(19) United States
(12) Patent Application Publication
(10) Pub. No.: US 2026/0169511 A1
(43) Pub. Date: Jun. 18, 2026

(54) LDO REGULATOR-BASED POWER SUPPLY CIRCUIT AND CHIP

(71) Applicants: GIGADEVICE SEMICONDUCTOR INC., Beijing (CN); SHENZHEN GEYI JUCHUANG INTEGRATED CIRCUIT CO., LTD., Shenzhen (CN); GIGADEVICE SEMICONDUCTOR (HEFEI) INC., Hefei (CN); GIGADEVICE SEMICONDUCTOR (SHANGHAI) INC., Shanghai (CN); GIGADEVICE SEMICONDUCTOR (XIAN) INC., Xi'an (CN); SILEAD INC., Shanghai (CN); SUZHOU FREETHINK INFORMATION TECHNOLOGY CO., LTD., Suzhou (CN)

(72) Inventor: Liang CHEN, Beijing (CN)

(73) Assignees: GIGADEVICE SEMICONDUCTOR INC., Beijing (CN); SHENZHEN GEYI JUCHUANG INTEGRATED CIRCUIT CO., LTD., Shenzhen (CN); GIGADEVICE SEMICONDUCTOR (HEFEI) INC., Hefei (CN); GIGADEVICE SEMICONDUCTOR (SHANGHAI) INC., Shanghai (CN); GIGADEVICE SEMICONDUCTOR (XIAN) INC., Xi'an (CN); SILEAD INC., Shanghai (CN); SUZHOU FREETHINK INFORMATION TECHNOLOGY CO., LTD., Suzhou (CN)

(21) Appl. No.: 19/410,080

(22) Filed: Dec. 5, 2025

(30) Foreign Application Priority Data
Dec. 16, 2024 (CN) 202411855783.1

(51) Int. Cl. G05F 1/575; G05F 1/565

(52) U.S. Cl. CPC G05F 1/575; G05F 1/565

(57) ABSTRACT

The present invention provides an LDO regulator-based power supply circuit and a chip. The LDO regulator-based power supply circuit includes first and second LDO regulators. It also includes a first current monitoring circuit and/or a second current monitoring circuit. When there is a need for switching from operation based on one of the LDO regulators to operation based on the other LDO regulator, feedback factors or reference voltages of two LDO regulators are configured at different values in a simultaneous turn-on interval, in which they are both ON, and a comparison is made with a detected current, allowing adaptive turn-off of the LDO regulator. After this LDO regulator is turned off, the feedback factor or reference voltage of the LDO regulator that is caused to start operation due to switching is adjusted to restore the LDO regulator-based power supply circuit to the same output voltage as prior to the switching.

### CROSS-REFERENCES TO RELATED APPLICATION

This application claims the priority of Chinese patent application number 202411855783.1, filed on Dec. 16, 2024, the entire contents of which are incorporated herein by reference.

### TECHNICAL FIELD

The present invention relates to the field of regulator-based power supplies, and particularly to a low-dropout (LDO) regulator-based power supply circuit and a chip.

### BACKGROUND

Due to process and power consumption limitations, it is not suitable to directly power internal circuits of complex system-on-chip (SOC) systems using external pins. Instead, these internal circuits are typically powered with a low voltage converted from a voltage from a high-voltage pin by a low-dropout (LDO) regulator. More complex chip systems may incorporate multiple LDO regulators, one of which can be selected to supply power to a given load circuit (e.g., an internal low-voltage circuit, such as a digital circuit), depending on a mode of operation or power consumption of the chip, or on a pin layout of the chip package. This would involve switching between two LDO regulators with different input power supply voltages for providing a load current to a single load circuit.

However, the switching is faced with two challenges: during the switching between the two LDO regulators, the load current must be maintained stable; and during the switching, the load voltage (i.e., output voltage) VL must not experience any significant drop or ripple.

Currently, switching between LDO regulators is typically accomplished by timing control, or using a single-pole double-throw (SPDT) switch. However, neither of these approaches can address both the above challenges. Therefore, there is a need for a novel approach capable of smooth switching between LDO regulators while ensuring a stable power supply output during the switching.

### SUMMARY

The present invention provides a low-dropout (LDO) regulator-based power supply circuit including a first LDO regulator, a second LDO regulator and a control module. The second and first LDO regulators are coupled to each other at output terminals thereof to provide an output voltage over different periods of time. The LDO regulator-based power supply circuit further includes a first current monitoring circuit and/or a second current monitoring circuit. The first current monitoring circuit is coupled to the first LDO regulator, and is configured to detect a current through a power transistor in the first LDO regulator and compare the detected current with a first threshold current. The second current monitoring circuit is coupled to the second LDO regulator, and is configured to detect a current through a power transistor in the second LDO regulator and compare the detected current with a second threshold current.

Based on the same inventive concept, the present invention also provides a chip including: the LDO regulator-based power supply circuit as defined above; and a load circuit coupled to the output voltage provided by the LDO regulator-based power supply circuit.

### BRIEF DESCRIPTION OF THE DRAWINGS

Those of ordinary skill in the art will understand that the following drawings are presented to enable a better understanding of the present invention and not intended to limit the scope thereof in any sense, in which:

FIG. 1 is a schematic diagram showing the architecture of a conventional chip with two LDO regulators;

FIG. 2 is a schematic timing diagram of switching of the chip of FIG. 1 from supplying power from an LDO regulator 1 to supplying power from an LDO regulator 2;

FIG. 3 is a schematic diagram showing the architecture of an LDO regulator-based power supply circuit according to a first embodiment of the present invention;

FIGS. 4A to 4C are schematic diagrams showing the architecture of respective exemplary implementations of the LDO regulator 2 in the LDO regulator-based power supply circuit according to the first embodiment of the present invention;

FIG. 5 is a schematic diagram showing the architecture of an exemplary implementation of a control module according to the first embodiment of the present invention;

FIG. 6 is a schematic flowchart of a process of switching of the LDO regulator-based power supply circuit according to the first embodiment of the present invention from supplying power from the LDO regulator 1 to supplying power from the LDO regulator 2;

FIG. 7 is a schematic timing diagram of the switching of the LDO regulator-based power supply circuit according to the first embodiment of the present invention from supplying power from the LDO regulator 1 to supplying power from the LDO regulator 2;

FIG. 8 is a schematic diagram showing the architecture of an LDO regulator-based power supply circuit according to a second embodiment of the present invention;

FIG. 9 is a schematic diagram showing the architecture of an exemplary implementation of a LDO regulator 1 in the LDO regulator-based power supply circuit according to the second embodiment of the present invention;

FIG. 10 is a schematic flowchart of a process of switching of the LDO regulator-based power supply circuit according to the first embodiment of the present invention from supplying power from the LDO regulator 1 to supplying power from the LDO regulator 2;

FIG. 11 is a schematic timing diagram of the switching of the LDO regulator-based power supply circuit according to the first embodiment of the present invention from supplying power from the LDO regulator 2 to supplying power from the LDO regulator 1;

FIG. 12 is a schematic timing diagram of the switching of the LDO regulator-based power supply circuit according to the second embodiment of the present invention from supplying power from a LDO regulator 2 to supplying power from the LDO regulator 1;

FIG. 13 is a schematic diagram showing the architecture of an LDO regulator-based power supply circuit according to a third embodiment of the present invention;

FIG. 14 is a schematic diagram showing the architecture of an LDO regulator-based power supply circuit according to a fourth embodiment of the present invention;

FIG. 15 is a schematic diagram showing the architecture of an LDO regulator-based power supply circuit according to a fifth embodiment of the present invention; and

FIG. 16 is another schematic diagram showing the architecture of the LDO regulator-based power supply circuit according to the fifth embodiment of the present invention.

### DETAILED DESCRIPTION

The following description sets forth numerous specific details in order to provide a more thorough understanding of the present invention. However, it will be apparent to those skilled in the art that the present invention can be practiced without one or more of these specific details. In other instances, well-known technical features have not been described in order to avoid unnecessary obscuring of the invention. It is to be understood that the invention may be embodied in many different forms and should not be construed as being limited to the embodiments set forth below. Rather, these embodiments are provided so that this disclosure is thorough and conveys the scope of the invention to those skilled in the art. In the drawings, like reference numerals refer to like elements throughout. It will be understood that when an element is referred to as being “connected to” or “coupled to” another element, it can be directly connected or coupled to the other element, or intervening elements may also be present. In contrast, when an element is referred to as being “directly connected to” another element, there are no intervening elements. As used herein, the singular forms “a”, “an” and “the” are intended to include the plural forms as well, unless the context clearly indicates otherwise. It will be further understood that the term “comprising” specifies the presence of stated features, steps, operations, elements, and/or components, but do not preclude the presence or addition of one or more other features, steps, operations, elements, components, and/or groups thereof. As used herein, the term “and/or” includes any and all combinations of the associated listed items.

As discussed in the Background section, complex chip systems may incorporate multiple low-dropout (LDO) regulators, one of which can be selected to supply power to a given load circuit (e.g., an internal low-voltage circuit, such as a digital circuit), depending on a mode of operation or power consumption of the chip, or on a pin layout of the chip package. This would involve switching between two LDO regulators with different input power supply voltages for providing a load current to a single load circuit. Such switching between LDO regulators may occur during, for example, initial startup of the chip, switching from a stop mode (in which peripheral circuitry and CPU cores and memory in the chip are all shut down) to a run mode (in which the peripheral circuitry and internal circuits of the chip operate normally) and from the run mode to the stop mode, and so forth.

A more detailed description is set forth below in the exemplary context of switching between two LDO regulators during initial startup of a chip, with reference to the accompanying drawings.

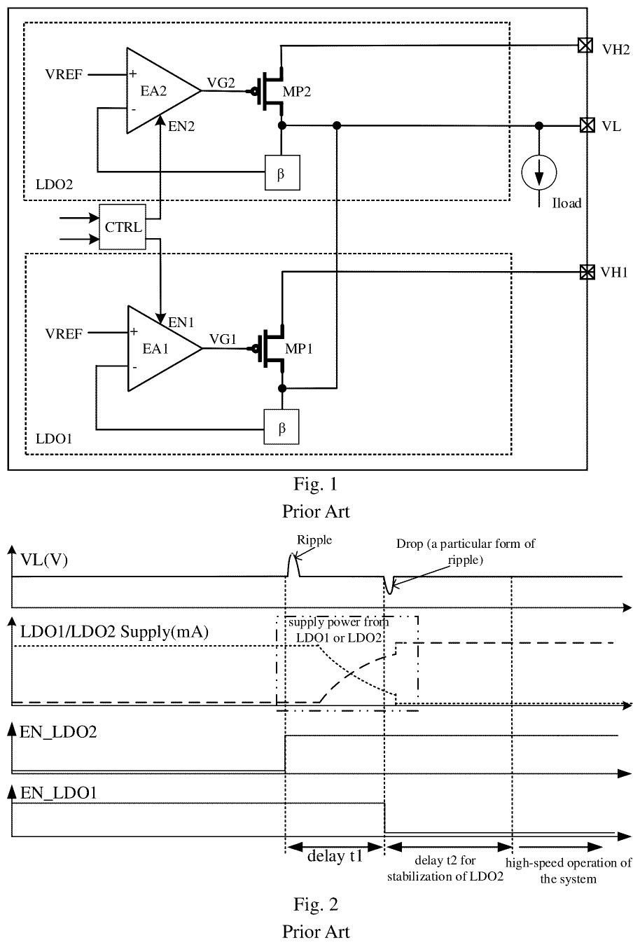

Referring to FIG. 1, a chip includes two low-dropout (LDO) regulators, referred to hereinafter as the LDO regulators 1 and 2. Output terminals of the LDO regulators 1 and 2 are both coupled to an output voltage pin VL to separately supply power, as needed, to a single load circuit (not shown) in the chip with at different times. The LDO regulators 1 and 2 have the same feedback factor, which is equal to β. The LDO regulator 1 is coupled to a power-supply voltage pin VH1, and the LDO regulator 2 is coupled to a power-supply voltage pin VH2. Different power supply voltages are provided to the LDO regulators 1 and 2. For ease of understanding, VH1 also represents the power supply voltage provided to the LDO regulator 1 (also referred to hereinafter as a “first power supply voltage”). Likewise, VH2 also represents the power supply voltage provided to the LDO regulator 2 (“second power supply voltage”). For example, VH1>VH2. Further, VL also represents an output voltage of an LDO regulator-based power supply circuit consisting of the LDO regulators 1 and 2.

With combined reference to FIG. 2, when the LDO regulators 1 and 2 separately supply power to the output voltage pin VL, comparable load currents Iload are provided. During initial startup of the chip, the LDO regulator 1 operates to continually supply power to the internal load circuit (not shown) of the chip via the output voltage pin VL, in the form of an internal power supply voltage, which satisfies the fundamental electrical current need of the chip. However, due to a great voltage drop between VH1 (e.g., 5 V) and VL, an associated power transistor MP1 (sometimes referred to hereinafter as a “first power transistor”) will consume much power when the load current Iload is large, causing considerable heat generation of the chip. Accordingly, the system typically turns off the LDO regulator 1 and turns on the LDO regulator 2 upon detecting energization of VH2 after it has operated for a certain period of time, thereby switching from the LDO regulator 1 to the LDO regulator 2, so that LDO regulator 2 instead supplies power to the load circuit via the output voltage pin VL. Due to a small voltage drop between VH2 (e.g., 1.5 V) and VL, an associated power transistor MP2 (“second power transistor”) will not consume significant power even when the load current is large, leading to less heat generation of the chip.

However, as can been seen from FIG. 2, the switching of the power supply from the LDO regulator 1 to the LDO regulator 2 is faced with the following challenges:
1) the turn-off of the LDO regulator 1 and turn-on of the LDO regulator 2 may introduce ripple or a significant drop (which is virtually also a form of ripple) to the output voltage VL;
2) there is a period of time during which the LDO regulators 1 and 2 are both ON (e.g., as indicated as contained in the dash-dot box of FIG. 2) and interfere with each other, adversely affecting the stability;
3) after the LDO regulator 1 is turned off, the switching to the LDO regulator 2 can be attained only after stabilization for a period of time (delay t1), increasing the time taken by system control; and
4) after the LDO regulator 2 is turned on, the system can reach an intended high operating speed only after stabilization for a preset period of time (delay t2), additionally increasing the time taken by system control.

In view of this, the present invention provides an LDO regulator-based power supply circuit and a chip, in which during switching between two LDO regulators, a control module configures feedback factors or reference voltages of the two LDO regulators to different values and adaptively turns off, based on an undercurrent flag signal from a current monitoring circuit, one of the two LDO regulators to be turned off. After the LDO regulator to be turned off is turned off, it additionally adjusts the feedback factor or reference voltage of a newly turned-on one of the two LDO regulators so that smooth switching between the two LDO regulators is achieved while ensuring that a stable load current is provided. In this way, equal output voltages are provided before and after the switching, and the time required by system control can be reduced.

The present invention will be described in greater detail below with reference to the accompanying drawings, which illustrate specific embodiments thereof. From the following description, advantages and features of the present invention will become more apparent. Note that the figures are provided in a very simplified form not necessarily drawn to exact scale for the only purpose of facilitating easy and clear description of the embodiments disclosed herein.

### Example 1

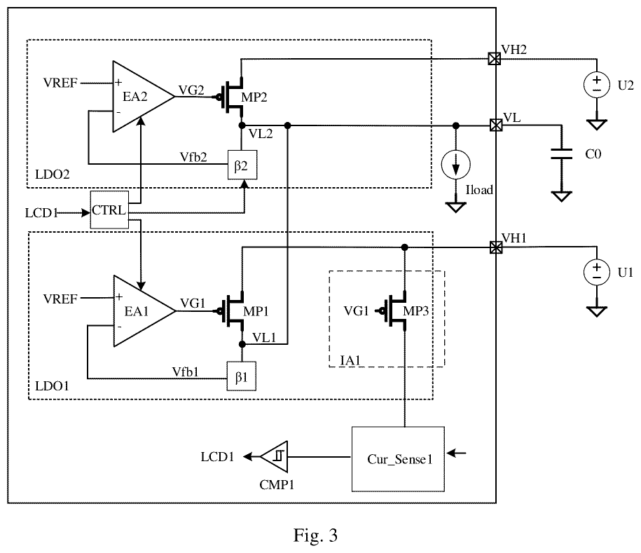

Referring to FIG. 3, in a first embodiment of the present invention, there is provided an LDO regulator-based power supply circuit including a first LDO regulator (referred to hereinafter as the “LDO regulator 1”), a second LDO regulator (“LDO regulator 2”), a control module CTRL and a first current monitoring circuit. These modules may be integrated in a single chip.

Output terminals of the LDO regulators 1 and 2 are coupled to the same node (e.g., a single output voltage pin of the chip) to provide an output voltage VL to the output voltage pin, or to a single load circuit. The LDO regulators 1 and 2 separately supply power to the output voltage pin in the form of comparable load currents Iload.

In this embodiment, the LDO regulators 1 and 2 are provided with first and second power supply voltages VH1, VH2, respectively, which satisfy VH1>VH2. For example, VH1 is 5 V, and VH2 is 1.5 V. The LDO regulators 1 and 2 are provided with the same reference voltage VREF. A feedback factor β1 of the LDO regulator 1 during its stable operation is different from its feedback factor β2 during startup of the LDO regulator 2. VREF may be provided by a bandgap reference voltage circuit (e.g., via an associated voltage-dividing resistor network). For example, when VL=1.1V is needed, the bandgap reference voltage circuit may provide a reference voltage equal to 1.2 V, which is then divided by the voltage-dividing resistor network to produce VREF fixed at 0.9 V.

During use of the present invention, the LDO regulator 1 is first turned on and operates to output a voltage VL1 as the output voltage VL that the LDO regulator-based power supply circuit provides an associated internal load circuit (not shown) of the chip. Upon detecting energization of VH2 after the LDO regulator 1 has operated for a period of time, it becomes necessary for the chip system to switch to the other LDO regulator. Accordingly, the LDO regulators 1 and 2 are turned off and on, respectively, so that the output voltage VL is instead provided by the LDO regulator 2. That is, between the LDO regulators 1 and 2, the LDO regulator 1 is the one to be turned off, and the LDO regulator 2 is the one to be turned on.

Accordingly, in this embodiment, the first current monitoring circuit is coupled to the LDO regulator 1 to detect a current Id1 through a first power transistor MP1 in the LDO regulator 1 in real time and compare the detected current Id1 with a first threshold current Ith1. The first current monitoring circuit may compare the current Id1 through the first power transistor MP1 with the first threshold current Ith1 using any suitable method. For example, the current Id1 through the first power transistor MP1 may be mirrored to Id3=Id1/n, which may be then compared with a first threshold value Ith1/n derived from Ith1.

The control module CTRL is coupled to the first current monitoring circuit and the LDO regulator 2, and is configured, when the LDO regulator 1 has started operation independent of the LDO regulator 2, turn on the LDO regulator 2 when so needed (e.g., when the power supply voltage VH2 is provided to the LDO regulator 2 after the LDO regulator 1 has operated for a period of time). As a result, a simultaneous turn-on interval starts, in which the LDO regulators 1 and 2 are both ON. In this interval, the control module CTRL configures the feedback factor β2 of the LDO regulator 2 to be different from the feedback factor β1 of the LDO regulator 1, thereby adaptively turning off the LDO regulator 1. The turn-off of the LDO regulator 1 further takes into account the comparison of the first current monitoring circuit (e.g., the current Id1 from MP1 is smaller than the first threshold current Ith1, or the mirrored current Id3 provided by MP3 is smaller than Ith1/n). After the LDO regulator 1 is turned off, the feedback factor β2 of the LDO regulator 2 that has been turned on (or newly turned on after the switching) is adjusted (e.g., β2=β1) so that the output voltage VL becomes equal to the value prior to the switching. That is, after the LDO regulator 1 is turned off, β2 is adjusted to tune a voltage VL2 output from the LDO regulator 2 to VL1 from the LDO regulator 1 during its operation. In this way, smooth switching can be accomplished from the independent operation of the LDO regulator 1 to independent operation of the LDO regulator 2, which ensures that the LDO regulator-based power supply circuit provides a stable load current Iload while preventing the output voltage VL from experiencing any significant drop or ripple during the switching.

It will be understood that, in this embodiment, the LDO regulator 1, the LDO regulator 2, the first current monitoring circuit and the control module CTRL may each be of any suitable circuit design, as long as the functions as described above can be delivered.

Optionally, the LDO regulator 1 may include a first error amplifier EA1, the first power transistor MP1 and a first feedback resistor network (which has a feedback factor optionally fixed at β1).

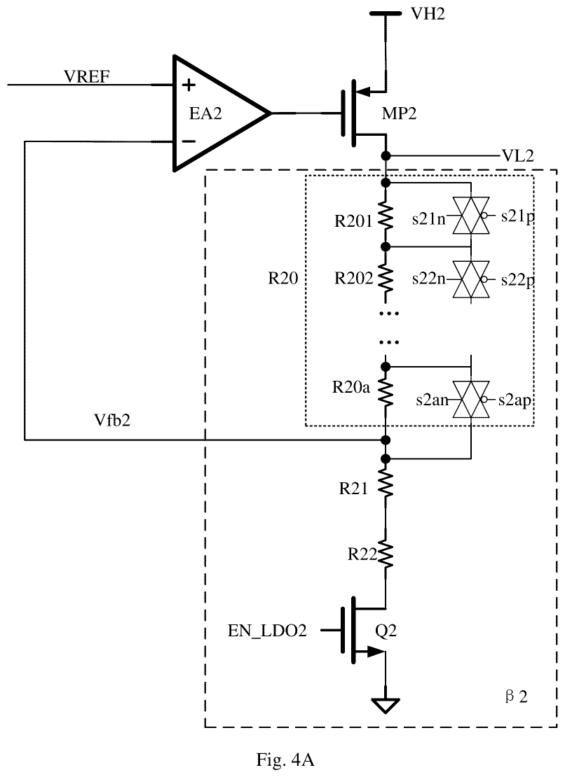

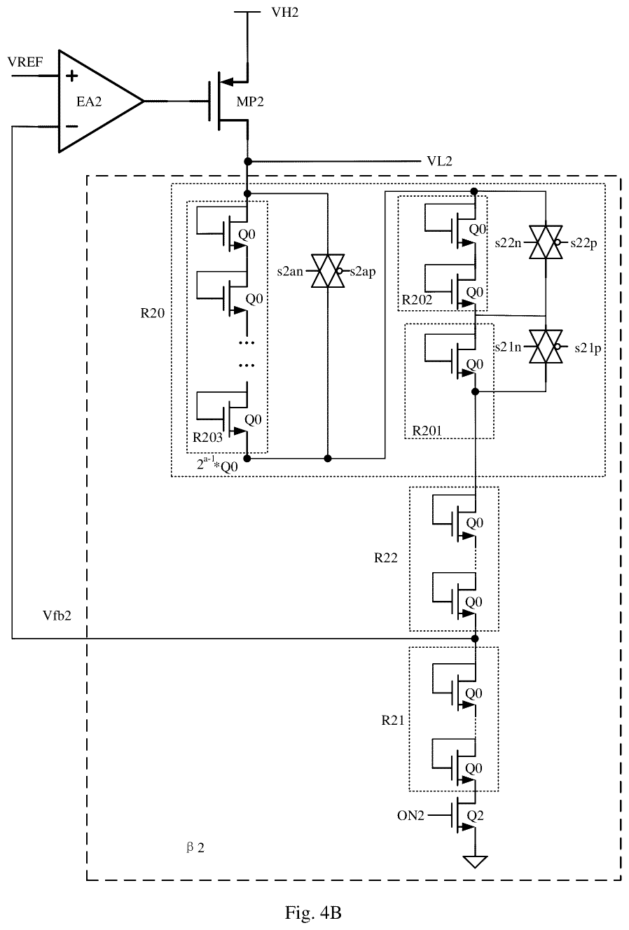

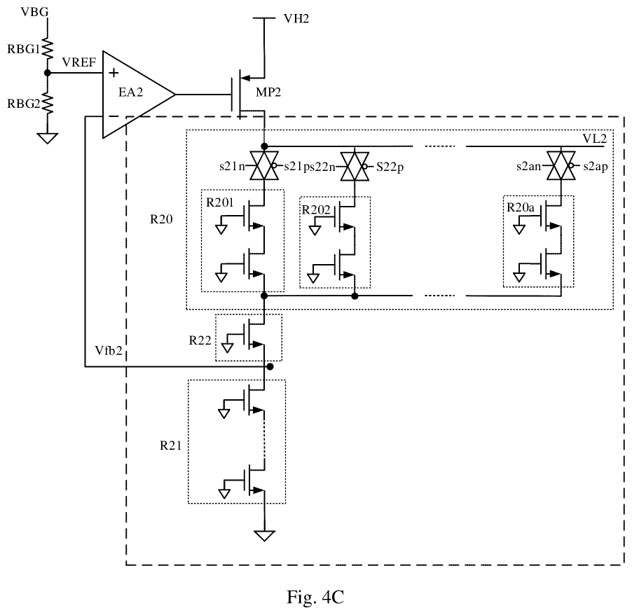

The first feedback resistor network includes a voltage-dividing resistor string consisting of at least two fixed resistors connected in series (not shown, but similar to R21 and R22 of FIG. 4A) and a switch transistor connected to a leading or trailing terminal of the voltage-dividing resistor string (not shown, but similar to Q2 of FIG. 4A). The voltage-dividing resistor string is coupled at the leading terminal to a drain terminal of the first power transistor MP1 directly, or indirectly via the switch transistor, to divide the output voltage VL1 thereof and thereby output a feedback voltage Vfb1 to a second (e.g., inverting “−”) input terminal of the first error amplifier EA1. It is also used to provide the fixed feedback factor β1 (=Vfb1/VL1) of the LDO regulator 1. The fixed resistors in the voltage-dividing resistor string may each be a polysilicon resistor, an SMD resistor, a MOS resistor, a carbon film resistor, a metal film resistor, a metal oxide film resistor, or the like. Furthermore, the switch transistor connected in series with the leading or trailing terminal of the voltage-dividing resistor string is coupled at a gate terminal thereof to the control module CTRL to be turned on or off based on an enable signal EN_LDO1 output from the control module CTRL. For example, the switch transistor, and hence LDO 1, may be turned on when the enable signal EN_LDO1 is at a high level. In addition, the switch transistor, and hence LDO 1, may be turned off when the enable signal EN_LDO1 is at a low level.

A first (e.g., non-inverting “+”) input terminal of the first error amplifier EA1 receives the reference voltage VREF, and the second (e.g., inverting “−”) input terminal of the first error amplifier EA1 receives the feedback voltage Vfb1. An output terminal of the first error amplifier EA1 is coupled to a gate terminal of the first power transistor MP1 to provide the first power transistor MP1 with a gate voltage VG1, and a source terminal of the first power transistor MP1 is coupled to the first power supply voltage VH1.

Optionally, the first current monitoring circuit may include a first mirror circuit IA1, a first current sensing circuit Cur_sense1 and a first comparator CMP1. Optionally, the first mirror circuit IA1 may include a first mirror transistor MP3, wherein the gate terminal of the first power transistor MP1 is coupled to a gate terminal of the first mirror transistor MP3, and the source terminal of the first power transistor MP1 is coupled to a source terminal of the first mirror transistor MP3. Thus, the gate terminal of the first mirror transistor MP3 is connected to an electrical potential VG1, and the source terminal thereof is connected to the first power supply voltage VH1.

In addition, MP1 and MP3 may be implemented by two separate independent MOS transistors, or by a cascode transistor. MP3 and MP1 have equal lengths but widths at a MP3/MP1 ratio of 1:n. With this arrangement, a (mirrored) current Id3 output from MP3 is equal to Id1/n, where Id1 represents the output current of MP1 in the LDO regulator 1, and n is the MP1/MP3 width ratio, which is greater than 0. When n>1, the mirrored current from MP3 is attenuated to one n-th of that from MP1. When 0<n<1, the mirrored current from MP3 is amplified to 1/n times that from MP1.

The first current sensing circuit Cur Sense1 may monitor and sample the output current Id3 of MP3 (i.e., Id1/n) in real time, and may perform processing on the sampled current Id3 (i.e., Id1/n), such as filtering the signal and converting it into a voltage. The processed signal may be output to the first comparator CMP1, which may then compare it with the associated threshold. In this way, real-time monitoring of the current Id1 from MP1 can be achieved. When the current Id3=Id1/n sampled by the first current sensing circuit is smaller than the first threshold value Ith1/n (i.e., when the current Id1 from the MP1 is <Ith1), the first comparator CMP1 may output a valid first undercurrent flag signal LCD1 (indicating the detection of an undercurrent event; e.g., LCD1 is valid when at a high level). In this case, the control module CTRL may turn off the LDO regulator 1 based on the valid LCD1 signal and, accordingly, configure the feedback factors of the LDO regulator 2 and 1 to different values (i.e., β2≠β1) in the simultaneous turn-on interval in which the LDO regulators 1 and 2 are both ON, causing the first error amplifier EA1 in the LDO regulator 1 to adaptively increase its output voltage VG1. Consequently, the first power transistor MP1 in the LDO regulator 1 is adaptively turned off, achieving the switching between the LDO regulators. The first threshold value is defined as the first threshold current Ith1 divided by the mirror ratio n of the first mirror circuit IA1 in the first current monitoring circuit, i.e., as Ith1/n.

Optionally, when the current Id1/n sampled by the first current sensing circuit is greater than a third threshold value Ith3/n, the first comparator CMP1 may output a valid first overcurrent flag signal OCD1 (indicating the detection of an overcurrent event; e.g., OCD1 is valid when at a high level). In response, the control module CTRL may control the LDO regulator 1 or another related circuit to take a proper countermeasure based on the valid OCD1 signal.

Optionally, the LDO regulator 2 may include a second error amplifier EA2, a second power transistor MP2 and a second feedback resistor network (which provides the adjustable feedback factor β2). A first (e.g., non-inverting “+”) input terminal of the second error amplifier EA2 receives the reference voltage VREF. An output terminal of the second error amplifier EA2 is coupled to a gate terminal of the second power transistor MP2 to provide the second power transistor MP2 with a gate voltage VG2, and a source terminal of the second power transistor MP2 is coupled to the second power supply voltage VH2. A drain terminal of the second power transistor MP2 is coupled to an input terminal of the second feedback resistor network, and a second input terminal of the second error amplifier EA2 is coupled to an output terminal of the second feedback resistor network to receive a feedback voltage Vfb2 from the output terminal of the second feedback resistor network. The feedback voltage Vfb2 is feedback of the voltage VL2 output from the LDO regulator 2. A control terminal of the second feedback resistor network is coupled to the control module CTRL, and the feedback voltage Vfb2 output from the second feedback resistor network is at a ratio to the output voltage VL2, which is equal to the feedback factor β2 of the LDO regulator 2, i.e., β2=Vfb2/VL2.

Optionally, with combined reference to FIGS. 4A to 4C, the second feedback resistor network may include a third resistor R20, a fourth resistor R21 connected in series with the third resistor R20, and a switch transistor Q2. The third resistor R20 and the fourth resistor R21 are connected in series at the output terminal of the second feedback resistor network, where the feedback voltage Vfb2 is output. One of R20 and R21 is a second adjustable resistor, and the control module CTRL controls and adjusts the resistance of the second adjustable resistor (e.g., R20) by outputting a binary code s21n-s2an, or by outputting the binary code s21n-s2an and its complement s21p-s2ap, thereby controlling or adjusting the feedback factor β2 of the LDO regulator 2, and hence β1/β2. The switch transistor Q2 is connected in series with the third resistor R20 and the fourth resistor R21 and receives, at its gate terminal, an enable signal EN_LDO2 output from the control module CTRL. Q2 is turned on or off under the control of the enable signal EN_LDO2, thereby turning on or off the LDO regulator 2.

Optionally, the second feedback resistor network may further include a fixed resistor R22, in addition to the third resistor R20, the fourth resistor R21 and the switch transistor Q2. The fixed resistor R22 is connected in series with the switch transistor Q2, the third resistor R20 and the fourth resistor R21 to provide current-limiting protection.

It will be further understood that the second adjustable resistor (R20 or R21) may be implemented by any suitable adjustable resistor component (e.g., an adjustable SMD resistor, etc.) or circuit design (e.g., a resistor string combined with an electronic switch array, etc.) The fixed resistor R22 and the fixed one of R20 and R21 may each be implemented by any suitable resistor component, such as a polysilicon resistor, an SMD resistor, a MOS resistor, a carbon film resistor, a metal film resistor or a metal oxide film resistor, or by a resistor string.

In one example, referring to FIG. 4A, the third resistor R20 is the second adjustable resistor and includes a series-connected resistor components R201-R20a, and complementary switches are connected in parallel to the respective resistor components. The control module CTRL outputs an a-bit binary code s2<a:1>n (i.e., the binary code s21n-s2an) and an a-bit binary complement s2<a:1>p thereof (i.e., the binary code s21p-s2ap), where a is an integer greater than 1. The complementary switch connected in parallel to R201 is under the control of the binary digit s2in and its complement s21p so that R201 is short-circuited when the switch is turned on and that R201 is connected in as a voltage-dividing resistor when the switch is turned off; the complementary switch connected in parallel to R202 is under the control of the binary digit s22n and its complement s22p so that R202 is short-circuited when the switch is turned on and that R202 is connected in as a voltage-dividing resistor when the switch is turned off; . . . ; and the complementary switch connected in parallel to R20a is under the control of the binary digit s2an and its complement s2ap so that R20a is short-circuited when the switch is turned on and that R20a is connected in as a voltage-dividing resistor when the switch is turned off.

In this example, the resistor components R201-R20a may be resistors made of the same material. For example, each of them may be a polysilicon resistor, an SMD resistor, a carbon film resistor, a metal film resistor, a metal oxide film resistor, or the like. The resistor components R201-R20a may have the same or different resistances. For example, the resistances of the resistor components R201-R20a may form a geometric sequence with a common ratio of 2 or 1/2. In this way, the feedback factor β2 of the LDO regulator 2 can be efficiently adjusted, as required.

In this example, the second power transistor MP2, the third resistor R20, the fourth resistor R21, the fixed resistor R22 and the switch transistor Q2 are sequentially connected in series. Agate terminal of the switch transistor Q2 receives the enable signal EN_LDO2 output from the control module CTRL. A source terminal of the switch transistor Q2 is grounded, and a drain terminal thereof is connected to one end of R22. The feedback voltage Vfb2 is output at a node, where R21 is connected in series with R20. The fixed resistor R22 can provide current-limiting protection. Thus, the feedback factor that the second feedback resistor network provide can be expressed as:

β2=Vfb2/VL2=R20/(R20+R21+R22).

Apparently, the control module CTRL uses the binary code s21n-s2an and the complement s21p-s2ap thereof to turn on or off the complementary switches connected in parallel to the respective resistor components R201-R20a to adjust the resistance of the third resistor R20 in the circuit, thereby controlling and adjusting β2. In this way, simpler control can be achieved by combining the closed-loop architecture with the binary code for controlling or adjusting of the feedback factor β2 of the LDO regulator 2.

In other examples, the fixed resistor R22 may be series-connected between the third resistor R20 and the fourth resistor R21 (see FIG. 4B), or between the drain terminal of MP1 and the third resistor R20. In these cases, β2=Vfb2/VL2=(R20+R22)/(R20+R21+R22). Alternatively, it may be series-connected between the source terminal of Q2 and the ground. In this case, β2=Vfb2/VL2=R20/(R20+R21+R22).

In a further example, referring to FIG. 4B, the third resistor R20 is the second adjustable resistor and includes a series-connected resistor components R201-R20a, and complementary switches are connected in parallel to the respective resistor components. Each of the resistor components R201-R20a consists of at least one series-connected MOS resistor Q0, each of which may have an identical or different width-to-length ratio. The second power transistor MP2, the third resistor R20, the fixed resistor R22, the fourth resistor R21 and the switch transistor Q2 are sequentially connected in series, and the feedback voltage Vfb2 is output at a node where the fixed resistor R22 is connected in series with the fourth resistor R21. Likewise, each of the fixed resistor R22 and the fourth resistor R21 consists of at least one MOS resistor Q0 (e.g., 2 series-connected MOS resistors Q0).

In this example, the feedback factor that the second feedback resistor network provides can be expressed as:

β2=Vfb2/VL2=(R20+R22)/(R20+R21+R22).

Apparently, the control module CTRL uses the binary code s21n-s2an and the complement s21p-s2ap thereof to turn on or off the complementary switches connected in parallel to the respective resistor components R201-R20a to adjust the resistance of the third resistor R20 in the circuit, thereby controlling and adjusting β2.

In this example, optionally, each MOS resistor Q0 may have an identical width-to-length ratio. However, the numbers of MOS resistors Q0 in the respective resistor components R201-R20a may form a geometric sequence with a common ratio of 2 or 1/2. For example, the resistor component R201 may consist of a single MOS resistor Q0, R202 of 2 series-connected MOS resistors Q0, . . . , R20a of 2ⁿ⁻¹ series-connected MOS resistors Q0.

In a further example, referring to FIG. 4C, the third resistor R20 is the second adjustable resistor and includes a series-connected resistor components R201-R20a, and complementary switches are connected in parallel to the respective resistor components. Each of the resistor components R201-R20a consists of at least one MOS resistor (not labeled), each of which may have an identical or different width-to-length ratio. The second power transistor MP2, the third resistor R20, the fixed resistor R22, the fourth resistor R21 and the switch transistor Q2 are sequentially connected in series, and the feedback voltage Vfb2 is output at a node where the fixed resistor R22 is connected in series with the fourth resistor R21. Likewise, each of the fixed resistor R22 and the fourth resistor R21 consists of at least one MOS resistor Q0 (e.g., 2 series-connected MOS resistors Q0).

In this example, the feedback factor that the second feedback resistor network provides can be expressed as:

β2=Vfb2/VL2=(R20+R22)/(R20+R21+R22).

Apparently, the control module CTRL uses the binary code s21n-s2an and the complement s21p-s2ap thereof to turn on or off the complementary switches connected in parallel to the respective resistor components R201-R20a to adjust the resistance of the third resistor R20 in the circuit, thereby controlling and adjusting β2.

In this example, each of the resistor components R201-R20a includes the same number of MOS resistors with identical width-to-length ratios. However, in alternatively examples, the resistor components R201-R20a may include different numbers of MOS resistors Q0 having the same width-to-length ratio. In other alternative examples, each of the resistor components R201-R20a includes the same number of MOS resistors with different width-to-length ratios.

In alternative examples, R20 may be the fixed resistor, and R21 may be the second adjustable resistor.

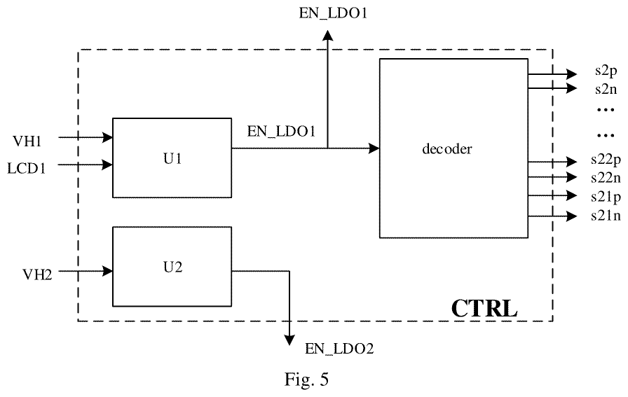

Optionally, referring to FIG. 5, the control module CTRL may include a first enable and control module U1, a second enable and control module U2 and a binary encoder/decoder. The first enable and control module U1 may produce the enable signal EN_LDO1 by performing a logical operation on VH1 and LCD1. For example, if VH1 is high and LCD1 is low, the resulting enable signal EN_LDO1 may be high and used to turn on the LDO regulator 1. If VH1 and LCD1 are both high, the resulting enable signal EN_LDO1 may be low and used to turn off the LDO regulator 1. The second enable and control module U2 may produce the enable signal EN_LDO2 based on VH2. For example, if VH2 is high, the produced enable signal EN_LDO2 may be high and used to turn on the LDO regulator 2. If VH2 is low, the produced enable signal EN_LDO2 may be low and used to turn off the LDO regulator 2.

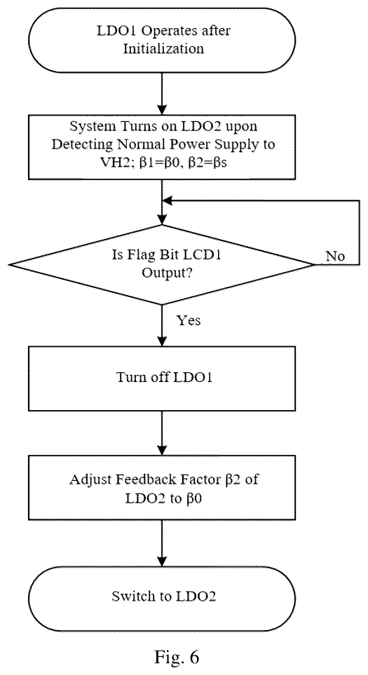

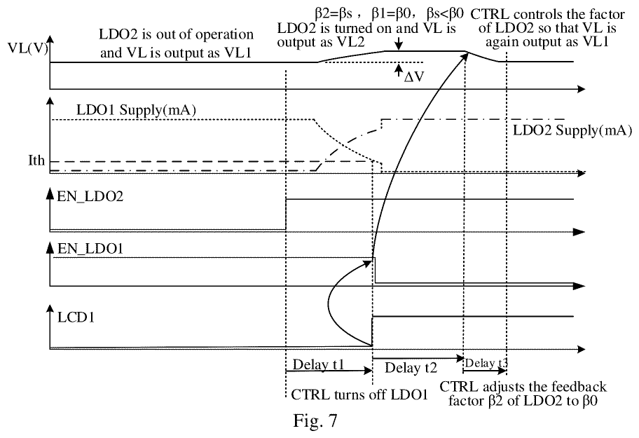

Operation of the LDO regulator-based power supply circuit of the present embodiment is described in detail below in the exemplary context of its structure shown in FIG. 3 and the circuit structure of the LDO regulator 2 of any of the examples shown in FIGS. 4A to 4C, with additionally reference to FIGS. 6 to 7. In this example, after the LDO regulator 1 operates independently for a while, it becomes necessary to turn off the LDO regulator and turn on the LDO regulator 2. A process of switching of the LDO regulator-based power supply circuit from supplying power from the LDO regulator 1 to supplying power from the LDO regulator 2 is detailed below.

First of all, during initialization, VH1 is powered on. Accordingly, EN_LDO1 is high, and the LDO regulator 1 operates independently. During this independent operation, the LDO regulator 1 outputs the voltage VL1 that satisfies VL1=VREF/β1, according to the closed-loop control theory, where β1 may be equal to β0 during this period. The first current monitoring circuit monitors the current through MP1 in real time. Since MP1 and MP3 have equal lengths l and their widths w are at a ratio of n, currents through MP3 and MP1 are at an Id3:Id1 ratio of 1/n, according to Id=1/2*k*(Vgs−Vth)²*(w/l).

Subsequently, when it becomes necessary for the system to switch between the LDO regulators, VH2 is powered on. Accordingly, EN_LDO2 is high and the LDO regulator 2 is turned on, starting a simultaneous turn-on interval, in which both the LDO regulators 1 and 2 are ON. According to the closed-loop control theory, the LDO regulator 2 outputs the voltage VL2=VREF/β2 during its operation. Accordingly, the control module sets β2 at βs (an initial value, typically fixed). As βs is lower than β1, VL2 is higher than VL1. Under the action of the simultaneous operation of the two LDO regulators, VL gradually increases from VL1 to VL2 that is slightly higher and then remains stable at VL2.

After VL becomes stable at VL2, VL1=VL=VL2=VREF/β2, Vfb2=VL2 and Vfb1=VL2*β1 are met. The voltages at the two input terminals of the error amplifier EA1 in the LDO regulator 1 are not equal, and their difference ΔV can be expressed as ΔV=Vfb1−VREF=VL2*β1−VREF=VREF/β2*β1−VREF=VREF*(β1/β2−1). As β2=βs<β1, ΔV>0, and EA1 has a gain of Gain1. Thus, the voltage VG1 at the gate terminal of MP1 gradually rises to the saturation point, Gain1*VREF*(β1/β2−1). If Gain1*VREF*(β1/β2−1)>VH1, then VG1 will increase to a value close to VH1, and MP1 will adaptively develop a trend towards eventual turn-off. In other words, in the simultaneous turn-on interval, if the values of β1, β2, Gain1 and VREF are appropriately configured, the voltage VG1 at the gate terminal of MP1 will rise to the saturation point, autonomously turning off MP1. The rise of the voltage VG1 will also induce a gradual decrease in the current Id1 through MP1, and hence in the mirrored current Id3 through MP3.

After that, upon the first current sensing circuit Cur_Sense1 detecting that the current Id3 reaches Id1/n below Ith1/n, the first comparator CMP1 outputs the valid LCD1 signal (e.g., at a high level), the control module CTRL pulls down the enable signal EN_LDO1 (until it becomes invalid) based on LCD1 and VH1. After EN_LDO1 is pulled low, the LDO regulator 1 is completely turned off, and the load current Iload is instead essentially provided through the power transistor MP2 in the LDO regulator 2. As the first power transistor MP1 in the LDO regulator 1 no longer serves to provide a current, no ripple will be introduced to VL.

Additionally, after a delay time Delay t2 elapses since EN_LDO1 is pulled down, the factor β2 is restored from βs to β1 prior to the switching, i.e., β2=β1, causing the voltage VL to gradually drop to VL1 before the switching (this lasts for a period of time Delay t3). In this way, smooth switching is achieved from supplying power from the LDO regulator 1 to supplying power from the LDO regulator 2, without VL experiencing any significant drop or ripple.

Delay t2 may be appropriately set according to the requirements of the system on the smoothness of switching between the LDO regulators, the time taken by system control and the like, and the present invention is not limited to any particular value of Delay t2. For example, it may be as long, or shorter than, as shown in FIG. 2.

It will be understood that, in this embodiment, in order to adaptively turn off MP1 in the LDO regulator 1 after the LDO regulator 2 is turned on, it is necessary for the voltage VG1 at the gate terminal of MP1 to adaptively increase to Gain1*VREF*(β1/β2−1)>VH1. Therefore, the duration Delay t1 of the simultaneous turn-on interval in the process of switching from supplying power from the LDO regulator 1 to supplying power from the LDO regulator 2 should be determined based on a comprehensive consideration of the reference voltage VREF, β1/β2 and Gain1.

In one example, parameters of the simultaneous turn-on interval, including VREF, β1/β2 and Gain1, may be determined in advance and kept constant throughout the interval. In this way, Delay t1 of the simultaneous turn-on interval can be shortened as compared with that of FIG. 2, reducing the time taken by system control and mitigating mutual interference of the two LDO regulators introduced by their simultaneous operation, which is harmful to the stability of the system.

Further, the total duration from the time when EN_LDO2 transitions to the high level (i.e., immediately after the LDO regulator 2 is turned on) to the time immediately following the restoration of VL after the switching to VL1 prior to the switching, which is equal to Delay t1+Delay t2+Delay t3, can be controlled to be shorter than the conventional total delay time (e.g., delay1+delay2, in the case of FIG. 2) to additionally shorten the time taken by system control and facilitate high-speed operation of the system.

In another example, parameters of the simultaneous turn-on interval, including initial VREF and β1/β2 values and Gain1, may be determined in advance, and VREF, β1 and Gain1 may be maintained constant throughout the interval. On the other hand, β2 can be adjusted through the second feedback resistor network. That is, in the simultaneous turn-on interval, instead of being fixed at the initial value βs, β2 can be changed to various values. For example, in the simultaneous turn-on interval, β2 may gradually decrease over time, or experience one or more abrupt changes, to increase β1/β2 to an appropriate value, or at an appropriate rate to a desired value. This allows Gain1*VREF*(β1/β2−1) to increase to a voltage close to VH1 within a shorter period of time, i.e., making Delay t1 shorter than as shown in FIG. 2, while ensuring smooth switching of VL. In this way, the time taken by system control can be reduced, and mutual interference of the two LDO regulators introduced by their simultaneous operation can be mitigated, which is harmful to the stability of the system.

Furthermore, it will be understood that, the above examples are presented merely to exemplify and illustrate this embodiment, and are not intended to limit the scope of the present invention in any way. In other embodiments of the invention, if required, the electronic components in the LDO regulator-based power supply circuit may be replaced with any suitable alternatives. For example, the complementary switches in FIGS. 4A to 4C may be replaced with electronic switches only under the control of the binary code s21n-s2an (e.g., MOS transistors, triodes, diodes, etc.), or electronic switches only under the control of the binary complement s21p-s2ap (e.g., MOS transistors, triodes, bipolar junction transistors (BJTs), silicon-controlled rectifiers (SCRs), diodes, etc.) As another example, if the MOS transistors of FIGS. 3 and 4A to 4C are PMOS transistors, they may be replaced with NMOS transistors, or if they are NMOS transistors, they may be replaced with PMOS transistors. In these cases, source terminals of the PMOS transistors are equivalent to drain terminals of the NMOS transistors, and drain terminals of the PMOS transistors are equivalent to source terminals of the NMOS transistors.

In the LDO regulator-based power supply circuit of this embodiment, the reference VREF is common to the two LDO regulators 1 and 2, and their output terminals are commonly connected to the output voltage pin (VL). With this arrangement, in the switching simultaneous turn-on interval in which the LDO regulators 1 and 2 are both ON, the feedback factors β1 and β2 of the LDO regulators 1 and 2, which are set to different values, as well as the gain and other properties of the EA1 in the LDO regulator 1, are leveraged to control current allocation between the power transistors MP1, MP2 of the two LDO regulators. Additionally, the current through MP1 is detected and serves as a basis for turning off MP1, and hence the LDO regulator 1. Subsequently, the feedback factor β2 of the LDO regulator 2 that has been turned on is adjusted to β1 prior to the switching, thus restoring the output voltage VL to VL1 before the switching. In this way, smooth switching between the LDO regulators can be achieved, which enables a stable power supply output voltage free of any significant drop or ripple.

### Example 2

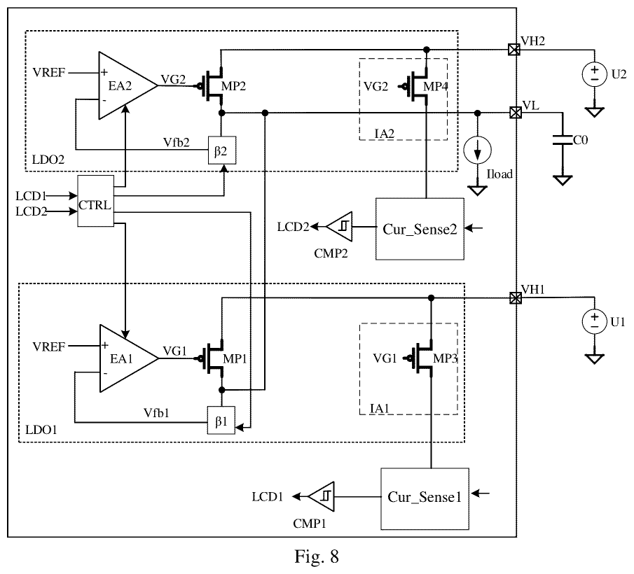

Referring to FIG. 8, in a second embodiment of the present invention, there is provided an LDO regulator-based power supply circuit also including an LDO regulator 1, another LDO regulator 2, a control module CTRL and a first current monitoring circuit. It differs from that of the first embodiment in (1) further including a second current monitoring circuit, which is coupled to the LDO regulator 2 and configured to detect a current Id2 through a second power transistor MP2 in the LDO regulator 2 and compare the detected current Id2 with a second threshold current Ith2; (2) further including a first adjustable resistor in a second feedback resistor network in the LDO regulator 1, which enables a feedback factor β1 thereof to be adjusted; and (3) the control module CTRL being further configured to turn on the LDO regulator 1 when it becomes necessary for the system to switch from supplying power from the LDO regulator 2 to supplying power from the LDO regulator 1. In response to the turn-on of the LDO regulator 1, a simultaneous turn-on interval starts, in which the LDO regulators 1 and 2 are both ON, and the feedback factor β1 of the LDO regulator 1 is configured to at a different value from a feedback factor β2 of the LDO regulator 2 (i.e., β3≠β2), thereby adaptively turning off MP2. According to a comparison made by the second current monitoring circuit (i.e., when the current Id2 through MP2 is detected to be smaller than the second threshold current Ith2), the LDO regulator 2 is turned off. After that, the feedback factor β1 of the LDO regulator 1 is adjusted (e.g., β1=β2) so that the same output voltage VL as before the switching is obtained.

In this embodiment, the first current monitoring circuit and the LDO regulator 2 may each be of any suitable circuit design. For example, the LDO regulator 2 may include a second error amplifier EA2, the second power transistor MP2 and the second feedback resistor network, and the first current monitoring circuit may include a first mirror circuit IA1, a first current sensing circuit Cur_sense1 and a first comparator CMP1. These components may be structured and connected in the same as in the first embodiment and, therefore, need not be described in further detail herein.

In this embodiment, the control module CTRL is not only able to provide the second feedback resistor network with an a-bit binary code s2<a:1>n (i.e., s21n-s2an) and an a-bit binary complement s2<a:1>p thereof (i.e., s21p-s2ap) according to an output of the first comparator CMP1, but is also able to provide a b-bit binary code s1<b:1>n (i.e., s11n-s1bn) and a b-bit binary complement s1<b:1>p thereof (i.e., sl1p-s1bp) to a first feedback resistor network in the LDO regulator 1 according to a comparison made by the second current monitoring circuit.

In this embodiment, the LDO regulator 1 includes a first error amplifier EA1, a first power transistor MP1 and the first feedback resistor network (which provides the adjustable feedback factor β1), and the LDO regulator 2 includes the second error amplifier EA2, the second power transistor MP2 and the second feedback resistor network (which provides the adjustable feedback factor β2). EA1, MP1 and the first feedback resistor network, as well as EA2, MP2 and the second feedback resistor network, are connected in the same manner as their counterparts of the first embodiment and, therefore, need not be described in further detail herein.

In this embodiment, the first feedback resistor network may be of any suitable circuit design.

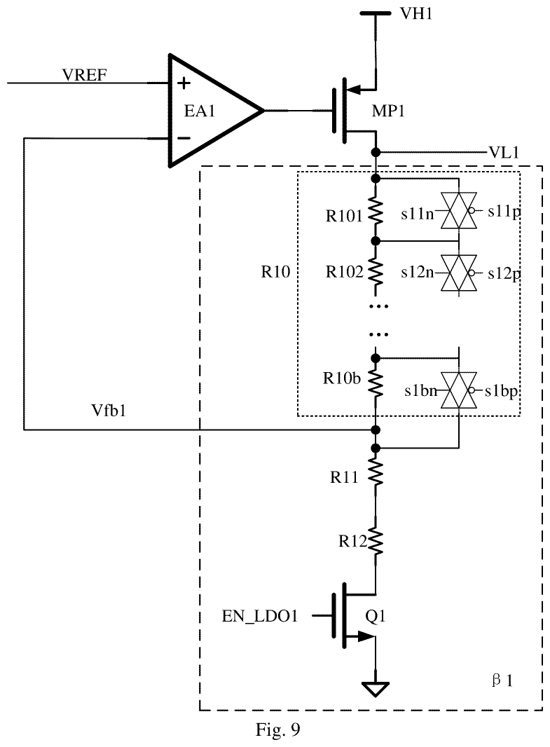

Optionally, referring to FIG. 9, the first feedback resistor network includes a first resistor R10, a second resistor R11, a fixed resistor R12 and a switch transistor Q1, which are connected in series with MP1. The first resistor R10 is connected in series with the second resistor R11 at an output terminal of the first feedback resistor network, from which a feedback voltage Vfb1 is output. One of R10 and R11 is a first adjustable resistor, and the control module CTRL also outputs a binary code and/or its complement for controlling and adjusting resistance of the first adjustable resistor R10, and hence the feedback factor pl1 of the LDO regulator 1. A gate terminal of the switch transistor in the first feedback resistor network receives an enable signal EN_LDO1 output from the control module CTRL, and the switch transistor can be turned on or off under the control of the enable signal EN_LDO1, thereby turning on or off the LDO regulator 1.

The first adjustable resistor (e.g., R10) may be implemented by any suitable adjustable resistor component (e.g., an adjustable SMD resistor, etc.) or circuit design (e.g., a resistor string combined with an electronic switch array, etc.) The fixed resistor R12 (with fixed resistance) and the fixed one of R11 and R10 may each be implemented by any suitable resistor component, such as a polysilicon resistor, an SMD resistor, a MOS resistor, a carbon film resistor, a metal film resistor or a metal oxide film resistor, or by a resistor string.

In one example, referring to FIG. 9, the first resistor R10 is the first adjustable resistor and includes b series-connected resistor components R101-R10b, and complementary switches are connected in parallel to the respective resistor components. The control module CTRL outputs a b-bit binary code s1<b:1>n (i.e., s11n-s1bn) and a b-bit binary complement s1<b:1>p thereof (i.e., s11p-s1bp) to control terminals of the complementary switches. Each element of the code short-circuits a respective one of the resistor components R101-R10b, or connects it into the system, allowing the resistance of the first resistor R10, and hence the feedback factor β1 of the LDO regulator 1, to be controlled and adjusted.

The resistor components R101-R10b may be resistors made of the same material. For example, each of them may be a polysilicon resistor, an SMD resistor, a carbon film resistor, a metal film resistor, a metal oxide film resistor, or the like. The resistor components R101-R10b may have the same or different resistances. For example, the resistances of the resistor components R101-R10b may form a geometric sequence with a common ratio of 2 or 1/2. In this way, the feedback factor β1 of the LDO regulator 1 can be efficiently adjusted, as required.

In this example, the feedback factor of the LDO regulator 1 can be expressed as: β1=Vfb1/VL1=R10/(R10+R11+R12).

In other examples, the fixed resistor R12 may be series-connected between the first resistor R10 and the second resistor R11, or between a drain terminal of MP1 and the first resistor R10. In these cases, β1=Vfb1/VL1=(R10+R12)/(R10+R11+R12). Alternatively, it may be series-connected between a source terminal of Q1 and the ground. In this case, β1=Vfb1/VL1=R10/(R10+R11+R12).

Optionally, referring to FIG. 8, the second current monitoring circuit may include a second mirror circuit IA2, a second current sensing circuit Cur_Sense2 and a second comparator CMP2. The second mirror circuit IA2 includes a second mirror transistor MP4. A gate terminal of the second power transistor MP2 is coupled to a gate terminal of the second mirror transistor MP4 (in order to receive VG2 output from EA2), and a source terminal of the second power transistor MP2 is coupled to a source terminal of the second mirror transistor MP4 (in order to receive VH2). Additionally, the two transistors are equally long and have a width ratio of m:1. With this arrangement, the current Id2 through the second power transistor MP2 can be mirrored at a ratio of 1:m, where m>1. That is, Id2/Id4=m:1. The second current sensing circuit Cur_Sense2 is coupled to a drain terminal of the MP4 in order to detect the mirrored current Id4 output from MP4. The second comparator CMP2 is coupled to an output terminal of the second current sensing circuit Cur_Sense2 and another input terminal of the control module CTRL, and is configured to compare the mirrored current Id4 detected by the second current sensing circuit Cur_Sense2 with an associated second threshold value Ith2/m. During switching from the LDO regulator 2 to the LDO regulator 1, upon detecting that the mirrored current Id4 is smaller than Ith2/m (i.e., Id2<Ith2), the second current sensing circuit Cur_Sense2 outputs a valid second undercurrent flag signal LCD2 (e.g., at a high level), which causes the control module CTRL to completely turn off the LDO regulator 2.

With this arrangement, monitoring of the current through the power transistor MP2 in the LDO regulator 2 can be accomplished by a simple circuit architecture, and in the simultaneous turn-on interval during switching from the LDO regulator 2 to the LDO regulator 1, in which the LDO regulator 2 and 1 are both ON, MP2 can be adaptively turn off. Furthermore, once the current through MP2 is detected to be too small, the control module CTRL can completely turn off the LDO regulator 2, facilitating high-speed operation of the system.

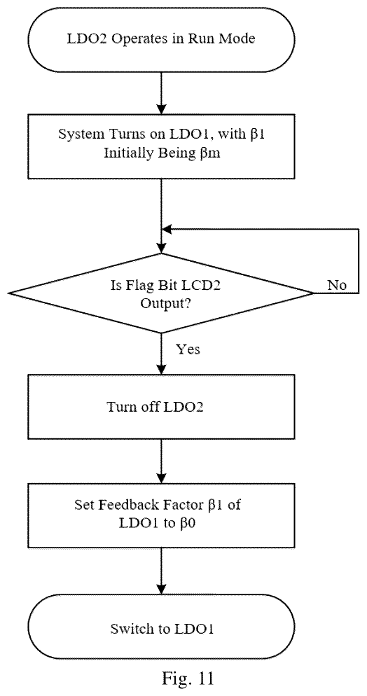

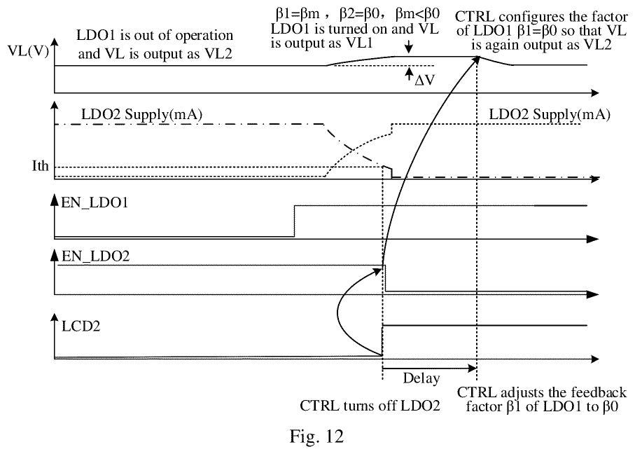

The LDO regulator-based power supply circuit of this embodiment is capable of: (1) switching from the LDO regulator 1 to the LDO regulator 2; and (2) switching from the LDO regulator 2 to the LDO regulator 1. Examples of the two switching scenarios will be described in detail below with reference to FIGS. 9 to 12.

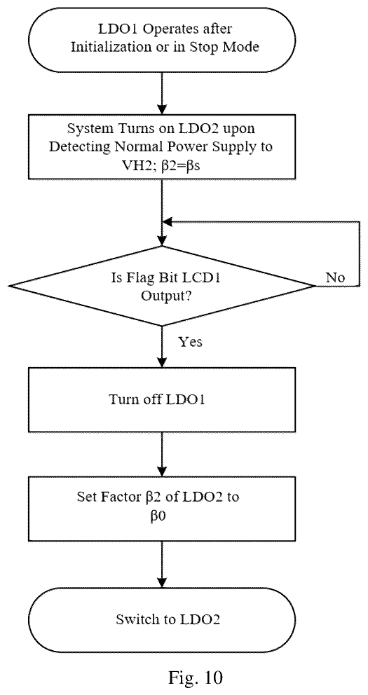

A process of switching from the LDO regulator 1 to the LDO regulator 2 will be described below with reference to FIGS. 8 and 10.

At first, during initialization or operation of the chip in a stop mode, VH1 is energized, EN_LDO1 is high, and the LDO regulator 1 operates independently. In this independent operation, according to the closed-loop control theory, the output voltage VL1 of the LDO regulator 1 satisfies VL1=VREF/β1, where β1 may be equal to β0 (optionally fixed, but required to be greater than β2 of the LDO regulator 2 in the simultaneous turn-on interval). At the same time, the first current monitoring circuit monitors the current through MP1 in real time. Since MP1 and MP3 have the same length l and their widths w are at a ratio of n, the currents through MP3 and MP1 are at an Id3:Id1 ratio of 1/n, according to Id=1/2*k*(Vgs−Vth)²*(w/l). The second current monitoring circuit remains out of operation throughout this stage.

Next, when it becomes necessary for the system to switch to operation based on the LDO regulator 2, VH2 is powered on. As a result, EN_LDO2 is high, turning on the LDO regulator 2 and initiating operation of the second current monitoring circuit. Accordingly, a simultaneous turn-on interval begins, in which the LDO regulators 1 and 2 are both ON, and LDO regulator 2 outputs a voltage VL2, which satisfies VL2=VREF/β2, according to the closed-loop control theory, where β2=βs<β0 (βs represents an initial value). Thus, VL2 is higher than VL1. Under the action of the simultaneous operation of the two LDO regulators, VL gradually increases from VL1 to VL2 that is slightly higher and then remains stable at VL2.

After VL becomes stable at VL2, VL1=VL=VL2=VREF/β2, Vfb2=VL2 and Vfb1=VL2*β1 are met. Voltages at two input terminals of the error amplifier EA1 in the LDO regulator 1 are not equal, and their difference ΔV can be expressed as ΔV=Vfb1−VREF=VL2*β1−VREF=VREF/β2*β1−VREF=VREF*(β1/β2−1). Because β2=βs<β1, ΔV>0, and EA1 has a gain of Gain1. Thus, a voltage VG1 at a gate terminal of MP1 gradually rises to the saturation point, Gain1*VREF*(β1/β2−1). If Gain1*VREF*(β1/β2−1)>VH1, then VG1 will increase to a value close to VH1, autonomously turning off MP1. In other words, if the values of β1/β2, Gain1 and VREF are appropriately configured, the voltage VG1 will rise to the saturation point, thus autonomously turning off MP1. In this way, current re-allocation between MP1 and MP2 is achieved in the simultaneous turn-on interval. The rise of the voltage at the gate terminal of MP1 leads to a gradual decrease in the current therethrough, and hence in the mirrored current Id3 through MP3.

It will be understood that, Gain1 and VREF remain constant throughout the simultaneous turn-on interval. Additionally, in this interval, either or both of β1 and β2 may be kept constant, or both β1 and β2 may be adjustable by the control module CTRL, as long as it is ensured that Gain1*VREF*(β1/β2−1) can increase to a voltage close to VH1. With Gain1 and VREF being maintained constant, either or both of β1 and β2 may be adjustable according to the system control and performance requirements so that β1/β2>1 and that β1/β2 rises to an appropriate value, or at an appropriate rate to a desired value. In this way, smooth switching of VL can be ensured, while allowing Gain1*VREF*(β1/β2−1) to increase to a voltage around VH1 within a shorter time. Thus, the simultaneous turn-on interval, and hence the time taken by system control, can be reduced.

Afterwards, when the first current sensing circuit Cur_Sense1 detects that the current Id3=Id1/n drops below Ith1/n, the first comparator CMP1 outputs a valid LCD1 signal (e.g., at a high level), and the control module CTRL responsively pulls down EN_LDO1 based on LCD1 and VH1, thereby completely turning off the LDO regulator 1. After that, a load current Iload is essentially provided instead through the second power transistor MP2 in the LDO regulator 2. As the first power transistor MP1 in the LDO regulator 1 no longer serves to provide a current, no ripple will be introduced to VL.

After a delay time elapses since EN_LDO1 is pulled down, the control module CTRL restores the factor β2 from βs to β0, i.e., to β1 prior to the switching. At this point, β2=β1=β0, causing the voltage VL to gradually decrease to VL1 before the switching (this lasts for a period of time Delay t3). In this way, smooth switching is achieved from supplying power from the LDO regulator 1 to supplying power from the LDO regulator 2, without causing any significant drop or ripple in VL.

Such switching may occur during initial startup of the chip, or in applications involving switching from a stop mode (in which a clock is stopped for all the peripheral circuitry, CPU cores and memory in a chip) to a run mode (in which the peripheral circuitry and internal circuits of the chip are in normal operation).

A process of switching from the LDO regulator 2 to the LDO regulator 1 will be described below with reference to FIGS. 8 and 11 to 12.

First of all, while the chip is operating in a run mode, VH2 is energized, EN_LDO2 is high, and the LDO regulator 2 operates independently. In this independent operation, according to the closed-loop control theory, the output voltage VL2 of the LDO regulator 2 satisfies VL2=VREF/β2, where β2 may be equal to β0 (optionally fixed, but required to be greater than β1 of the LDO regulator 1 in the simultaneous turn-on interval). At the same time, the second current monitoring circuit monitors the current through MP2 in real time. Since MP2 and MP4 have the same length l and their widths w are at a ratio of m, the currents through MP4 and MP2 are at an Id4:Id3 ratio of 1/m, according to Id=1/2*k*(Vgs−Vth)²*(w/l). The first current monitoring circuit remains out of operation throughout this stage.

Next, when it becomes necessary for the system to switch to operation based on the LDO regulator 1, VH1 is powered on. As a result, EN_LDO1 is high, turning on the LDO regulator 1 and initiating operation of the first current monitoring circuit. Accordingly, a simultaneous turn-on interval begins, in which the LDO regulators 1 and 2 are both ON, and LDO regulator 1 outputs the voltage VL1 that satisfies VL1=VREF/β1, according to the closed-loop control theory, where β1=βm<β0. Thus, VL1 is higher than VL2. Under the action of the simultaneous operation of the two LDO regulators, VL gradually increases from VL2 to VL1 that is slightly higher and then remains stable at VL1.

After VL becomes stable at VL1, VL2=VL=VL1=VREF/β1, Vfb1=VL1 and Vfb2=VL1*β2 are met. Voltages at two input terminals of the error amplifier EA2 in the LDO regulator 2 are not equal, and their difference ΔV can be expressed as ΔV=Vfb2−VREF=VL1*β2−VREF=VREF/β1*β2−VREF=VREF*(β2/β1−1). Because β1=βm<β0, ΔV>0, and EA2 has a gain of Gain2. Thus, a voltage VG2 at a gate terminal of MP2 gradually rises to Gain2*VREF*(β2/β1−1). If Gain2*VREF*(β2/β1−1)>VH2, then VG2 will increase to a value close to VH2. In other words, if the values of β1/β2, Gain2 and VREF are appropriately configured, the voltage VG2 will rise to a saturation point, thus autonomously turning off MP2. Thus, in the simultaneous turn-on interval, as the voltage VG2 at the gate terminal of MP2 gradually rises, the current Id2 therethrough, and hence the current Id4 through MP4, gradually decreases. It will be understood that, Gain2 and VREF are kept constant throughout the simultaneous turn-on interval. On the other hand, in this interval, either or both of β1 and β2 may be kept constant, or both β1 and β2 may be adjustable by the control module CTRL, as long as it is ensured that Gain2*VREF*(β2/β1−1) can increase to a voltage close to VH2. With Gain2 and VREF being maintained constant, either or both of β1 and β2 may be adjustable according to the system control and performance requirements so that β1/β2 rises to an appropriate value, or at an appropriate rate to a desired value (or β1/β2 rises to an appropriate value, or decreases at an appropriate rate to a desired value). In this way, smooth switching of VL can be ensured, while allowing Gain2*VREF*(β2/β1−1) to increase to a voltage around VH2 within a shorter time. Thus, the simultaneous turn-on interval, and hence the time taken by system control, can be reduced.

After that, when the second current sensing circuit Cur_Sense2 detects that the current Id4=Id2/m drops below Ith2/m, the second comparator CMP2 outputs a valid LCD2 signal (e.g., at a high level), and the control module CTRL responsively pulls down the enable signal EN_LDO2 based on LCD2 and VH2, thereby completely turning off the LDO regulator 2. Then, the load current Iload is essentially provided instead through the first power transistor MP1 in the LDO regulator 1. As the second power transistor MP2 in the LDO regulator 2 no longer serves to provide a current, no ripple will be introduced to VL.

After a delay time elapses since EN_LDO2 is pulled down, the control module CTRL restores the factor β1 from βm to β0 (i.e., to β2 prior to the switching). At this point, β1=β2=β0, causing the voltage VL to gradually decrease to VL2 before the switching. In this way, smooth switching is achieved from supplying power from the LDO regulator 2 to supplying power from the LDO regulator 1, without causing any significant drop or ripple in VL.

Such switching may occur in applications involving switching from a run mode of chip to a stop mode.

To sum up, through adding the second current monitoring circuit and additionally enabling the feedback factor of the LDO regulator 1 to be adjusted when so needed, compared with the first embodiment, the LDO regulator-based power supply circuit of this embodiment allows not only smooth switching from the LDO regulator 1 to the LDO regulator 2, as needed in initial startup, switching from a stop mode to a run mode, switching from the run mode to the stop mode, and other scenarios of a chip, but also smooth switching from the LDO regulator 2 to the LDO regulator 1, as needed in switching from the run mode to the stop mode and other scenarios of the chip. Therefore, it can be used in a wider range of applications.

### Example 3

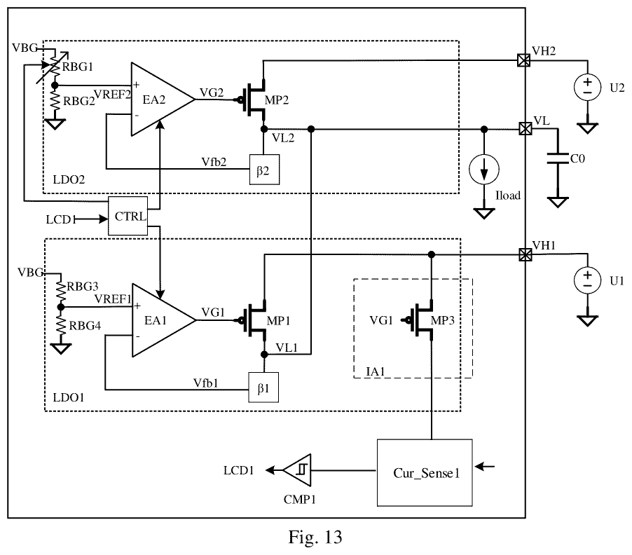

Referring to FIG. 13, in a third embodiment of the present invention, there is provided an LDO regulator-based power supply circuit also including an LDO regulator 1, another LDO regulator 2, a control module CTRL and a first current monitoring circuit. It differs from that of the first embodiment in (1) that the LDO regulator 1 receives a first reference voltage VREF1 and the LDO regulator 2 receives a second reference voltage VREF2, (2) that feedback factors β1 and β2 of the LDO regulators 1 and 2 are both fixed, and (3) that the control module CTRL is configured, in response to a need for switching is from supplying power from the LDO regulator 1 to supplying power from the LDO regulator 2, to turn on the LDO regulator 2, thereby initiating a simultaneous turn-on interval, in which the LDO regulators 1 and 2 are both ON. In addition, in this simultaneous turn-on interval, it is configured so that VREF1/VREF2, allowing MP1 in the LDO regulator 1 to be adaptively turned off. Further, according to a comparison made by the first current monitoring circuit (i.e., when it detects that a current Id1 through MP1 is smaller than a first threshold current Ith1, or that a current Id3 through MP3 is smaller than Ith1/n), an invalid enable signal EN_LDO1 is output to the LDO regulator 1 to turn it off. After the LDO regulator 1 is turned off, the reference voltage VREF2 received at the LDO regulator 2 is adjusted (e.g., VREF2=VREF1) so that the same output voltage VL is provided before and after the switching.

In this embodiment, LDO regulator 1, the first current monitoring circuit and the LDO regulator 2 may each be of any suitable circuit design. For example, the LDO regulator 1 may include a first error amplifier EA1, a first power transistor MP1 and a first feedback resistor network. The LDO regulator 2 may include a second error amplifier EA2, a second power transistor MP2 and a second feedback resistor network. The first current monitoring circuit may include a first mirror circuit IA1, a first current sensing circuit Cur_sense1 and a first comparator CMP1. These components may be structured and connected in the same manner as in the first embodiment and, therefore, need not be described in further detail herein. When the first feedback resistor network in the LDO regulator 1 and the second feedback resistor network in the LDO regulator 2 are each of the same circuit design as the first feedback resistor network in the LDO regulator 1 of the first embodiment (i.e., the one of R20 and R21 that is configured as a second adjustable resistor is omitted from the LDO regulator 2 of this embodiment), feedback factors β1 and β2 of the LDO regulators 1 and 2 are both kept constant. When the first feedback resistor network in the LDO regulator 1 and the second feedback resistor network in the LDO regulator 2 are each of a similar circuit design to the second feedback resistor network in the LDO regulator 2 of the first or second embodiment, the control module CTRL provides the first and second feedback resistor networks with a binary code and a binary complement thereof, respectively, which remain the same during and after switching, in order to allow the feedback factors β1 and β2 of the LDO regulators 1 and 2 to remain constant.

In this embodiment, β1 may be equal to β2, or not, but β1/β2 always remains the same.

In this embodiment, the LDO regulator-based power supply circuit further includes a first voltage-dividing resistor network and a second voltage-dividing resistor network. The first voltage-dividing resistor network is configured to divide a reference voltage VBG and output the first reference voltage VREF1 to the first error amplifier EA1 in the LDO regulator 1. The second voltage-dividing resistor network is configured to divide the reference voltage VBG and output the second reference voltage VREF2 to the second error amplifier EA2.

The second voltage-dividing resistor network includes a seventh resistor RBG1 and an eighth resistor RBG2 connected in series with RBG1. RBG1 receives the reference voltage VBG at its one end, and RBG1 and RBG2 are connected in series with each other at an output terminal of the second voltage-dividing resistor network, from which the second reference voltage VREF2 is output, and which is coupled to a first input terminal of EA2. VREF2=VBG*RBG1/(RBG1+RBG2). One of RBG1 and RBG2 is a fourth adjustable resistor with adjustable resistance, and the control module CTRL may adjust VREF2 by changing the resistance of the fourth adjustable resistor.

The first voltage-dividing resistor network includes a fifth resistor RBG3 and a sixth resistor RBG4 connected in series with RBG3. Both RBG3 and RBG4 are fixed resistors. One end of RBG3 receives the reference voltage VBG, and RBG3 and RBG4 are connected in series at an output terminal of the first voltage-dividing resistor network, from which the first reference voltage VREF1 is output, and which is coupled to a first input terminal of EA1. VREF1=VBG*RBG3/(RBG3+RBG4).

RBG3, RBG4 and the fixed one of RBG2 and RGB1, i.e., the aforementioned fixed resistors (the resistance of each of which is fixed but not adjustable), may each be implemented by any suitable resistor component, such as a polysilicon resistor, an SMD resistor, a MOS resistor, a carbon film resistor, a metal film resistor or a metal oxide film resistor, or by any suitable resistor-based circuit design.

The fourth adjustable resistor (e.g., RBG1) may be implemented by any suitable adjustable resistor component (e.g., an adjustable SMD resistor, etc.) or circuit design (e.g., a resistor string combined with an electronic switch array, etc.) This embodiment is not particularly limited in this regard.

For example, the fourth adjustable resistor may be RBG1, and may be of the same circuit design as the third resistor R20 of the first embodiment, when implemented as the second adjustable resistor. Therefore, it need not be described in further detail herein. Optionally, the fourth adjustable resistor may be RBG1, and may be implemented by a plurality of series-connected (e.g., see FIGS. 4A and 4B) or parallel-connected (e.g., see FIG. 4C) resistors, whose resistances form a geometric sequence with a common ratio of 2 or 1/2. With this arrangement, the resistance of RBG1 can be controlled, and the second reference voltage VREF2 can be controlled or adjusted, by a corresponding binary code output from the control module CTRL. In this way, simpler control can be achieved by combining the closed-loop architecture with the binary code for controlling or adjusting of the reference voltage at the LDO regulator 2.

Operation of the LDO regulator-based power supply circuit of this embodiment is described in detail below in the context of its exemplary structure shown in FIG. 13, as an example.

First of all, during initialization, VH1 is powered on. Accordingly, EN_LDO1 is high, and the LDO regulator 1 operates independently. During this independent operation, the LDO regulator 1 outputs a voltage VL1, which satisfies VL1=VREF1/β1, according to the closed-loop control theory. Both β1 and VREF1 may remain constant, and VREF1=VREF. At the same time, the first current monitoring circuit monitors the current through MP1 in real time. Since MP1 and MP3 have equal lengths l and their widths w are at a ratio of n, currents through MP3 and MP1 are at an Id3:Id1 ratio of 1/n, according to Id=1/2*k*(Vgs−Vth)²*(w/l).

Subsequently, when it becomes necessary for the system to switch between the LDO regulators, VH2 is powered on. Accordingly, EN_LDO2 is high and the LDO regulator 2 is turned on, starting a simultaneous turn-on interval, in which both the LDO regulators 1 and 2 are ON. According to the closed-loop control theory, the LDO regulator 2 outputs a voltage VL2 during its operation, which satisfies VL2=VREF2/β2. As β2 remains unchanged and VREF2=VREFs (an initial value), VREFs/β2 is generally greater than VREF1/β1 (e.g., when β2=β1=β0, VREFs>VREF). That is, VL2 is higher than VL1. Under the action of the simultaneous operation of the two LDO regulators, VL gradually increases from VL1 to VL2 that is slightly higher and then remains stable at VL2.

After VL becomes stable at VL2, the voltages at the two input terminals of the error amplifier EA1 in the LDO regulator 1 are not equal, and their difference ΔV can be expressed as ΔV=Vfb1−VREF1=VL2*1−VREF1=VREF2/β2*β1−VREF1=VREF1*[(VREF2/VREF1)*(β1/β2)−1]. Since VREFs/β2>VREF1/β1, ΔV>0, and EA1 has a gain of Gain1. Thus, a voltage VG1 at a gate terminal of MP1 gradually rises to the saturation point, Gain1*VREF1*[(VREF2/VREF1)*(β1/β2)−1]. If Gain1*VREF1*[(VREF2/VREF1)*(β1/β2)−1]>VH1, then VG1 will increase to a value close to VH1, adaptively turning off MP1. In other words, if the values of β1/β2, Gain1 and VREF2/VREF1 are appropriately configured, the voltage VG1 will rise to the saturation point, autonomously turning off MP1. This allows for current (Id1 and Id2) re-allocation between MP1 and MP2 in the simultaneous turn-on interval. The rise of the voltage VG1 at the gate terminal of MP1 will induce a gradual decrease in the current Id1, and hence in the mirrored current Id3 through MP3.

It will be understood that the values of VREF2, VREF1, Gain1, β1 and β2 configured in the simultaneous turn-on interval affect the rate at which Gain1*VREF1*[(VREF2/VREF1)*(β1/β2)−1] increases to VH1. That is, the duration of the simultaneous turn-on interval is determined based on a comprehensive consideration of the factors VREF2, VREF1, Gain1, β1 and β2. In the simultaneous turn-on interval, VREF1, Gain1, β1 and β2 are fixed, while VREF2 may be either fixed or adjustable by the control module CTRL, as long as it is ensured that Gain1*VREF1*[(VREF2/VREF1)*(β1/β2)−1] can increase to a voltage close to VH1. For example, with VREF1, Gain1, β1 and β2 being maintained constant, VREF2 may be increased to an appropriate value, or at an appropriate rate to a desired value, according to the system control and performance requirements. In this way, smooth switching of VL can be ensured, while allowing Gain1*VREF1*[(VREF2/VREF1)*(β1/β2)−1] to increase to a voltage around VH1 within a shorter time. Thus, the simultaneous turn-on interval, and hence the time taken by system control, can be reduced, and mutual interference of the two LDO regulators introduced by their simultaneous operation can be mitigated, which is harmful to the stability of the system.

Afterwards, when the first current sensing circuit Cur_Sense1 detects that the current Id3=Id1/n drops below Ith1/n, the first comparator CMP1 outputs a valid LCD1 signal (e.g., at a high level), and the control module CTRL responsively pulls down EN_LDO1 based on LCD1 and VH1, thereby completely turning off the LDO regulator 1. After that, a load current Iload is essentially provided instead through the second power transistor MP2 in the LDO regulator 2. As the first power transistor MP1 in the LDO regulator 1 no longer serves to provide a current, no ripple will be introduced to VL.

Additionally, after a delay time Delay t2 elapses since EN_LDO1 is pulled down, VREF2 is adjusted so that (VREF2/VREF1)*(β1/β2)=1. For example, when β2=β1, VREF2=VREFs<VREF1 in the simultaneous turn-on interval, and after the delay time Delay t2 since the pull-down of EN_LDO1 elapses, VREF2 may be restored from VREFs to VREF, i.e., VREF2=VREF1, causing the voltage VL to gradually drop to VL1 before the switching. In this way, smooth switching is achieved from supplying power from the LDO regulator 1 to supplying power from the LDO regulator 2, without VL experiencing any significant drop or ripple.

When comparing the operating principles of this embodiment with those of the first embodiment, it can be found that both designs are essentially based upon the concept that, in the simultaneous turn-on interval during switching from supplying power from the LDO regulator 1 to supplying power from the LDO regulator 2, in which the LDO regulators 1 and 2 are both ON, the voltage VG1 at the gate terminal of MP1 is adaptively increased to Gain1*VREF1*[(VREF2/VREF1)*(β1/β2)−1]>VH1. That is, VG1 is caused to rise to the saturation point around VH1, thus autonomously turning off MP1.

In the first embodiment, through configuring VREF2=VREF1=VREF, maintaining VREF and β1 constant and adding the adjustable resistor R20 to the second feedback resistor network in the LDO regulator 2, the feedback factor β2 of the LDO regulator 2 can be adjusted as required so that β2<β1 and VL2>VL1 in the simultaneous turn-on interval, in which the LDO regulators 2 and 1 are both ON, thereby adaptively turning off MP1, and hence the LDO regulator 1 completely. After the LDO regulator 1 is completely turned off, β2 is further adjusted so that β2=β0.

In contrast, in the present embodiment, through configuring VREF1=VREF and β2=β1, maintaining these factors constant and adding the second voltage-dividing resistor network that includes the seventh resistor RBG1 to the LDO regulator 2, the reference voltage VREF2 received at the LDO regulator 2 can be adjusted as needed so that VREF2>VREF and VL2>VL1 in the simultaneous turn-on interval, in which the LDO regulators 2 and 1 are both ON, thereby adaptively turning off MP1, and hence the LDO regulator 1 completely. After the LDO regulator 1 is completely turned off, VREF2 is further adjusted so that VREF2=VREF.

### Example 4

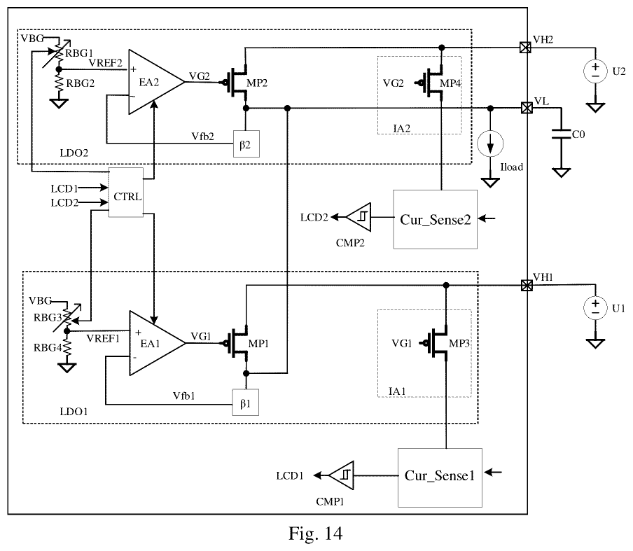

Referring to FIG. 14, in a fourth embodiment of the present invention, there is provided an LDO regulator-based power supply circuit also including an LDO regulator 1, another LDO regulator 2, a control module CTRL, a first current monitoring circuit, a first voltage-dividing resistor network and a second voltage-dividing resistor network. It differs from that of the third embodiment in (1) further including a second current monitoring circuit, which is coupled to the LDO regulator 2 and configured to detect a current through a power transistor MP2 in the LDO regulator 2 and compare the detected current with a second threshold current; and (2) configuring one of a fifth resistor RBG3 and a sixth resistor RBG4 in the first voltage-dividing resistor network in the LDO regulator 1 as a third adjustable resistor, which makes a reference voltage VREF1 thereof adjustable; and (3) the control module CTRL being further configured to turn on the LDO regulator 1 when it becomes necessary for the system to switch from supplying power from the LDO regulator 2 to supplying power from the LDO regulator 1. In response to the turn-on of the LDO regulator 1, a simultaneous turn-on interval starts, in which the LDO regulators 1 and 2 are both ON, and the control module CTRL configures the reference voltage VREF1 for the LDO regulator 1 at a different value from a reference voltage VREF2 for the LDO regulator 2, thereby adaptively turning off MP2. According to a comparison made by the second current monitoring circuit (i.e., when the current through MP2 is detected to be smaller than a first threshold current), the LDO regulator 2 is turned off. After that, the reference voltage VREF1 for the LDO regulator 1 is adjusted (e.g., VREF1=VREF2) so that the same output voltage VL as before the switching is obtained.

In this embodiment, the first and second current monitoring circuits, the first and second voltage-dividing resistor networks and the LDO regulators 1 and 2 may each be of any suitable circuit design, and the present invention is not limited to any particular circuit design. For example, the LDO regulator 1 may include a first error amplifier EA1, a first power transistor MP1 and a first feedback resistor network. The LDO regulator 2 may include a second error amplifier EA2, a second power transistor MP2 and a second feedback resistor network. The first current monitoring circuit may include a first mirror circuit IA1, a first current sensing circuit Cur_sense1 and a first comparator CMP1. The second current monitoring circuit may include a second mirror circuit IA2, a second current sensing circuit Cur_sense2 and a second comparator CMP2. The second voltage-dividing resistor network may include a seventh resistor RBG1 and an eighth resistor RBG2 connected in series with RBG1. The first voltage-dividing resistor network may include a fifth resistor RBG3 and a sixth resistor RBG4 connected in series with RBG3. These components may be structured and connected in the same way as in any of the first to third embodiments and, therefore, need not be described in further detail herein.

In this embodiment, the first feedback resistor network in the LDO regulator 1 provides a fixed feedback factor β1. The second feedback resistor network in the LDO regulator 2 provides a fixed feedback factor β2. One of RBG3 and RBG4 is a third adjustable resistor.

For example, RBG3 may be the third adjustable resistor, and switching from supplying power from the LDO regulator 1 to supplying power from the LDO regulator 2 may be accomplished in the same manner as in the third embodiment and, therefore, need not be described in further detail herein.

In this embodiment, the LDO regulator-based power supply circuit may go through the following process to switch from the LDO regulator 2 to the LDO regulator 1.

At first, while the chip is operating in a run mode, VH2 is energized, EN_LDO2 is high, and the LDO regulator 2 operates independently. In this independent operation, according to the closed-loop control theory, the LDO regulator 2 outputs a voltage VL2, which satisfies VL2=VREF2/β2, where β2 and VREF2 may be kept constant. At the same time, the first current monitoring circuit monitors a current Id2 through MP2 in real time. Since MP2 and MP4 have the same length l and their widths w are at a ratio of m, currents through MP4 and MP2 are at an Id4:Id3 ratio of 1/m, according to Id=1/2*k*(Vgs−Vth)²*(w/l).

Next, when it becomes necessary for the system to switch to the LDO regulator 1, VH1 is powered on. As a result, EN_LDO1 is high, turning on the LDO regulator 1 and starting simultaneous turn-on interval, in which the LDO regulators 1 and 2 are both ON. According to the closed-loop control theory, the LDO regulator 1 outputs a voltage VL1, which satisfies VL1=VREF1/β1. β1 is a constant value, and VREF1 may assume an initial value VREFs. VREFs/β1 is greater than VREF2/β2. That is, VL1 is higher than VL2. Under the action of the simultaneous operation of the two LDO regulators, VL gradually increases from VL2 to VL1 that is slightly higher and then remains stable at VL1.

After VL becomes stable at VL1, voltages at two input terminals of the error amplifier EA2 in the LDO regulator 2 are not equal, and their difference ΔV can be expressed as ΔV=Vfb2−VREF2=VL1*β2−VREF2=VREF1/β1*β2−VREF2=VREF2*[(VREF1/VREF2)*(β2/β1)−1]. Since VREFs/β2 is greater than VREF1/β1, ΔV>0, and EA2 has a gain of Gain2. Thus, a voltage VG2 at a gate terminal of MP2 gradually rises to the saturation point, Gain2*VREF2*[(VREF1/VREF2)*(β2/β1)−1]. If Gain2*VREF2*[(VREF1/VREF2)*(β2/β1)−1]>VH2, then VG2 will increase to a value close to VH2, adaptively turning off MP2. In other words, if the values of β2/β1, Gain2 and VREF1/VREF2 are appropriately configured in the simultaneous turn-on interval, the voltage VG2 will rise to the saturation point, autonomously turning off MP2. This allows for current re-allocation between MP1 and MP2 in the simultaneous turn-on interval. The rise of the voltage at the gate terminal of MP2 will induce a gradual decrease in the current therethrough, and hence in the mirrored current through MP4. It will be understood that the values of VREF1/VREF2, Gain2 and β2/β1 configured in the simultaneous turn-on interval affect the rate at which Gain2*VREF2*[(VREF1/VREF2)*(β2/β1)−1] increases to VH2. That is, the duration of the simultaneous turn-on interval are determined based on a comprehensive consideration of the factors VREF2, VREF1, Gain2, β1 and β2. In the simultaneous turn-on interval, VREF1, Gain2, β1 and β2 are fixed, while VREF1 may be either fixed or adjustable by the control module CTRL, as long as it is ensured that Gain2*VREF2*[(VREF1/VREF2)*(β2/β1)−1] can increase to a voltage close to VH2. For example, with VREF1, Gain2, β1 and β2 being maintained constant, VREF1 may be increased to an appropriate value, or at an appropriate rate to a desired value, according to the system control and performance requirements. In this way, smooth switching of VL can be ensured, while allowing Gain2*VREF2*[(VREF1/VREF2)*(β2/β1)−1] to increase to a voltage around VH2 within a shorter time. Thus, the time taken by system control can be reduced, and mutual interference of the two LDO regulators introduced by their simultaneous operation can be mitigated, which is harmful to the stability of the system.

After that, when the second current sensing circuit Cur_Sense2 detects that the current Id4=Id1/m drops below Ith2/m, the second comparator CMP2 outputs a valid LCD2 signal (e.g., at a high level), and the control module CTRL responsively pulls down the enable signal EN_LDO2 based on LCD1 and VH1, thereby completely turning off the LDO regulator 2. Then, a load current Iload is essentially provided instead through the first power transistor MP1 in the LDO regulator 1. As the second power transistor MP2 in the LDO regulator 2 no longer serves to provide a current, no ripple will be introduced to VL.

Additionally, after an appropriate delay time elapses since EN_LDO2 is pulled down, VREF1 is adjusted so that VREF1/VREF2*β2/1=1. For example, when β2=β1, VREF1 may be restored to VREF2 prior to the switching, causing the voltage VL to gradually drop to VL1 before the switching. In this way, smooth switching is achieved from supplying power from the LDO regulator 1 to supplying power from the LDO regulator 2, without VL experiencing any significant drop or ripple.

Below, a comparison is made between this embodiment and the second embodiment. In the second embodiment, through configuring VREF2=VREF1=VREF, maintaining VREF, Gain1 and Gain2 constant and adding the adjustable resistor R20 to the second feedback resistor network in the LDO regulator 2, the feedback factor β2 of the LDO regulator 2 can be adjusted as required. Moreover, through adding the adjustable resistor R10 to the first feedback resistor network in the LDO regulator 1, the feedback factor β1 of the LDO regulator 1 can also be adjusted as required. In this way, β2<β1=β0 and VL2>VL1 can be satisfied in the simultaneous turn-on interval during switching from the LDO regulator 1 to the LDO regulator 2, in which the LDO regulators 2 and 1 are both ON, thereby adaptively turning off MP1 in the LDO regulator 1. After MP1 is turned off, β2 can be adjusted so that β2=β0. Likewise, β1<β2=β0 and VL1>VL2 can be satisfied in the simultaneous turn-on interval during switching from the LDO regulator 2 to the LDO regulator 1, in which the LDO regulators 2 and 1 are both ON, thereby adaptively turning off MP2 in the LDO regulator 2. After MP2 is turned off, β1 can be adjusted so that β1=β0.

In contrast, in this embodiment, through keeping β2, β1, Gain1 and Gain2 constant and adding the second voltage-dividing resistor network including the seventh resistor RBG1 that is configured as the fourth adjustable resistor to the LDO regulator 2, the reference voltage VREF2 received at the LDO regulator 2 can be adjusted as needed. Moreover, through adding the first voltage-dividing resistor network including the fifth resistor RBG3 that is configured as the third adjustable resistor to the LDO regulator 1, the reference voltage VREF1 received at the LDO regulator 1 can be adjusted as needed. In this way, β2=β1=β0, VREF2>VREF1 and VL2>VL1 can be satisfied in the simultaneous turn-on interval during switching from the LDO regulator 1 to the LDO regulator 2, in which the LDO regulators 2 and 1 are both ON, thereby adaptively turning off MP1 in the LDO regulator 1. After MP1 in the LDO regulator 1 is turned off, VREF2 can be adjusted so that VREF2=VREF1. Likewise, β1=β2=β0, VREF1>VREF2 and VL1>VL2 can be satisfied in the simultaneous turn-on interval during switching from the LDO regulator 2 to the LDO regulator 1, in which the LDO regulators 2 and 1 are both ON, thereby adaptively turning off MP2 in the LDO regulator 2. After MP2 in the LDO regulator 2 is turned off, VREF1 can be adjusted so that VREF1=VREF2.

### Example 5

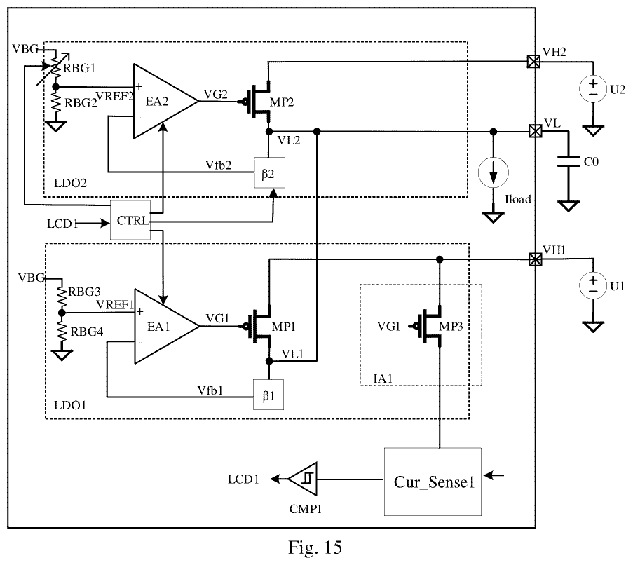

Referring to FIG. 15, in a fifth embodiment of the present invention, there is provided an LDO regulator-based power supply circuit also including an LDO regulator 1, another LDO regulator 2, a control module CTRL and a first current monitoring circuit. As in first embodiment, a feedback factor β2 of the LDO regulator 2 is also adjustable. This embodiment differs from the first embodiment in (1) the LDO regulator 1 receiving a first reference voltage VREF1 and additionally including the same second voltage-dividing resistor network that includes the fourth adjustable resistor as in the third embodiment, which enables the LDO regulator 2 to receive an adjustable second reference voltage VREF2, if needed; and (2) the control module CTRL being configured, when it becomes necessary for the system to switch from supplying power from the LDO regulator 1 to supplying power from the LDO regulator 2, turn on the LDO regulator 2, starting a simultaneous turn-on interval, in which the LDO regulators 1 and 2 are both ON. Moreover, in the simultaneous turn-on interval, it configures VREF2 VREF1, β1/β2 and (VREF2/VREF1)*(β1/β2)>1, thus adaptively turning off MP1. Further, based on a comparison made by the first current monitoring circuit (i.e., when it is detected that a current Id1 through MP1 drops below a first threshold current Ith1, or that a current Id3 through MP3 drops below Ith1/n), an enable signal EN_LDO1 is output to the LDO regulator 1, completely turning off the LDO regulator 1. After the LDO regulator 1 is turned off, the reference voltage VREF2 for the LDO regulator 2 and β1 are further adjusted so that (VREF2/VREF1)*(β1/β2)=1 is satisfied. Thus, the same output voltage VL is obtained as before the switching.

In this embodiment, the LDO regulator 1, the LDO regulator 2, the control module CTRL, the first current monitoring circuit, the second voltage-dividing resistor network and the other components in the LDO regulator-based power supply circuit may each be of any suitable circuit design. For example, the LDO regulator 1 may include a first error amplifier EA1, a first power transistor MP1 and a first feedback resistor network. The LDO regulator 2 may include a second error amplifier EA2, a second power transistor MP2 and a second feedback resistor network. The first current monitoring circuit may include a first mirror circuit IA1, a first current sensing circuit Cur_sense1 and a first comparator CMP1. The second voltage-dividing resistor network may include a seventh resistor RBG1 and an eighth resistor RBG2, which are connected in series with each other at a node where a second reference voltage VREF2 is output. The first voltage-dividing resistor network may include a fifth resistor RBG3 and a sixth resistor RBG4, which are both fixed resistors connected in series with each other. The second feedback resistor network may include a second adjustable resistor (e.g., R20 of FIG. 4A), and one of RBG1 and RBG2 may be a fourth adjustable resistor with adjustable resistance. These components may be structured and connected in the same manner as in the first and third embodiments and, therefore, need not be described in further detail herein.

The LDO regulator-based power supply circuit operates in a similar way to that of the third embodiment, except that, in this embodiment, after the LDO regulator 1 is turned off, the control module CTRL can adjust both the reference voltage VREF2 and the feedback factor β2 of the LDO regulator 2 so that (VREF2/VREF1)*(β1/β2)=1 is satisfied, allowing the same output voltage VL to be obtained as before switching.

Optionally, in addition to allowing for smooth switching between the LDO regulators 1 and 2, in the simultaneous turn-on interval during switching from supplying power from the LDO regulator 1 to supplying power from the LDO regulator 2, the control module CTRL in the LDO regulator-based power supply circuit of this embodiment can adjust both the reference voltage VREF2 and the feedback factor β2 of the LDO regulator 2 to ensure that VG1 can increase to Gain1*VREF1*[(VREF2/VREF1)*((β1/β2)−1]>VH1, thereby adaptively turning off MP1 in the LDO regulator 1. In this way, the duration of the simultaneous turn-on interval is controllable or adjustable.

### Example 6

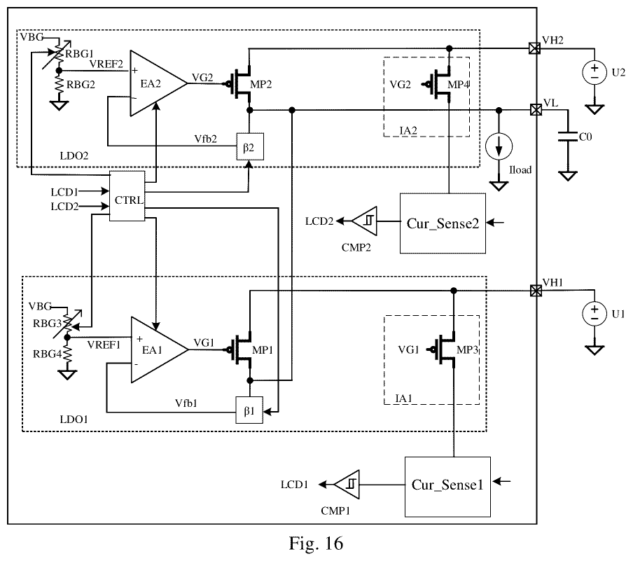

Referring to FIG. 16, in a sixth embodiment of the present invention, there is provided an LDO regulator-based power supply circuit also including an LDO regulator 1, another LDO regulator 2, a control module CTRL, a first current monitoring circuit and a second current monitoring circuit. Like the third embodiment, this embodiment also features adjustability of the feedback factors β2 and β1 of the LDO regulator 2 and 1. However, it differs from third embodiment in (1) further including a fourth adjustable resistor in the second voltage-dividing resistor network, which enables the LDO regulator 2 to receive an adjustable second reference voltage VREF2 if required, and a third adjustable resistor in the first voltage-dividing resistor network, which enables the LDO regulator 1 to receive an adjustable first reference voltage VREF1 if required; and (2) the control module CTRL being configured, when it becomes necessary for the system to switch from supplying power from the LDO regulator 1 to supplying power from the LDO regulator 2, turn on the LDO regulator 2, starting a simultaneous turn-on interval, in which the LDO regulators 1 and 2 are both ON. Moreover, in the simultaneous turn-on interval, it configures VREF2≠VREF1, β1≠β2 and (VREF2/VREF1)*(β1/β2)>1, thus adaptively turning off MP1 in the LDO regulator 1. Further, based on a comparison made by the first current monitoring circuit (i.e., when it is detected that a current Id1 through MP1 drops below a first threshold current Ith1, or that a current Id3 through MP3 drops below Ith1/n), an enable signal EN_LDO1 is output to the LDO regulator 1, completely turning off the LDO regulator 1. After the LDO regulator 1 is turned off, the reference voltage VREF2 for the LDO regulator 2 and β1 are further adjusted so that (VREF2/VREF1)*(β1/β2)=1 is satisfied. Thus, the same output voltage VL is obtained as before the switching. In addition, when it becomes necessary for the system to switch from supplying power from the LDO regulator 2 to supplying power from the LDO regulator 1, the LDO regulator 1 is turned on, initiating a simultaneous turn-on interval, in which the LDO regulators 1 and 2 are both ON. In this simultaneous turn-on interval, the control module CTRL configures VREF2 VREF1, β1/β2 and (VREF1/VREF2)*(β2/β1)>1, thus adaptively turning off MP2 in the LDO regulator 2. Based on a comparison made by the second current monitoring circuit (i.e., when it is detected that a current Id2 through MP2 drops below a second threshold current Ith2, or that a current Id4 through MP4 drops below Ith2/m), an enable signal EN_LDO2 is output to the LDO regulator 2, completely turning off the LDO regulator 2. After the LDO regulator 2 is turned off, the reference voltage VREF1 for the LDO regulator 1 and β2 are further adjusted so that (VREF1/VREF2)*(β2/β1)=1 is satisfied. Thus, the same output voltage VL is also obtained as before the switching.

In this embodiment, the LDO regulators 1 and 2, the control module CTRL, the first and second voltage-dividing resistor networks, the first and second voltage-dividing resistor networks and the other components in the LDO regulator-based power supply circuit may each be of any suitable circuit design. For example, the LDO regulator 1 may include a first error amplifier EA1, a first power transistor MP1, a first feedback resistor network and a first voltage-dividing resistor network. The LDO regulator 2 may include a second error amplifier EA2, a second power transistor MP2, a second feedback resistor network and a second voltage-dividing resistor network. The first current monitoring circuit may include first mirror circuit IA1, a first current sensing circuit Cur_sense1 and a first comparator CMP1. The second voltage-dividing resistor network may include a seventh resistor RBG1 and an eighth resistor RBG2, which are connected in series with each other at a node where VREF2 is output. The first voltage-dividing resistor network may include a fifth resistor RBG3 and a sixth resistor RBG4, which are connected in series with each other at a node where VREF1 is output. The first feedback resistor network includes a first adjustable resistor (e.g., R10 of FIG. 9), and the second feedback resistor network includes a second adjustable resistor (e.g., R20 of FIG. 4A). One of RBG1 and RBG2 is an fourth adjustable resistor with adjustable resistance, and one of RBG3 and RBG4 is a third adjustable resistor with adjustable resistance. These components may be structured and connected in the same manner as in the first to fifth embodiments and, therefore, need not be described in further detail herein.

In this embodiment, switching of the LDO regulator-based power supply circuit from supplying power from the LDO regulator 1 to supplying power from the LDO regulator 2 is accomplished in the same way as in the fifth embodiment and, therefore, need not be described in further detail herein. In order to switch the system from supplying power from the LDO regulator 1 to supplying power from the LDO regulator 2, after the LDO regulator 1 is turned off, the control module CTRL adjusts both the reference voltage VREF2 for the LDO regulator 2 and the feedback factor β2 to control VREF2/VREF1 and β1/β2 so that (VREF2/VREF1)*(β1/β2)=1 is satisfied. Thus, the same output voltage VL is obtained as before the switching.

In this embodiment, switching of the LDO regulator-based power supply circuit from supplying power from the LDO regulator 2 to supplying power from the LDO regulator 1 is accomplished in a similar manner to that of the fourth embodiment, except that, in order to switch the system from supplying power from the LDO regulator 2 to supplying power from the LDO regulator 1, after the LDO regulator 2 is turned off, the control module CTRL adjusts both the reference voltage VREF1 for the LDO regulator 1 and the feedback factor β1 to control VREF1/VREF2 and β2/β1 so that (VREF1/VREF2)*(β2/β1)=1 is satisfied. Thus, the same output voltage VL is also obtained as before the switching.

Optionally, during the switching from supplying power from the LDO regulator 2 to supplying power from the LDO regulator 1, in addition to allowing for smooth switching, in the simultaneous turn-on interval during this switching process, the control module CTRL can adjust both the reference voltage VREF1 for the LDO regulator 1 and the feedback factor β1 to ensure that VG2 can increase to Gain2*VREF2*[(VREF1/VREF2)*(β2/β1)−1]>VH2, thereby adaptively turning off the LDO regulator 2. In this way, the duration of the simultaneous turn-on interval is controllable or adjustable.

### Example 7

Referring to FIGS. 3 to 16, there is also provided a chip based on the same inventive concept, which includes an LDO regulator-based power supply circuit according to the present invention and a load circuit (not shown) coupled to the output voltage VL provided by the LDO regulator-based power supply circuit.

Since this chip incorporates the LDO regulator-based power supply circuit of the present invention, during switching between LDO regulators when needed, the load circuit can be provided with a stable load current, and the output voltage provided to the load circuit is free of any significant drop or ripple, imparting higher stability to the system.

Described above are merely a few preferred embodiments of the present invention, which are not intended to limit the scope of the present invention in any way. Any and all changes and modifications made by those of ordinary skill in the art in light of the above teachings are intended to fall within the scope of the invention.

What is claimed is:

1. A low-dropout (LDO) regulator-based power supply circuit, comprising a first LDO regulator, a second LDO regulator and a control module, wherein output terminals of the second and first LDO regulators are coupled to each other to provide an output voltage over different periods of time; the LDO regulator-based power supply circuit further comprises a first current monitoring circuit and/or a second current monitoring circuit, the first current monitoring circuit coupled to the first LDO regulator and configured to detect a current through a power transistor in the first LDO regulator and compare the detected current with a first threshold current, the second current monitoring circuit coupled to the second LDO regulator and configured to detect a current through a power transistor in the second LDO regulator and compare the detected current with a second threshold current;
the control module is configured, when there is a need for switching between the LDO regulators, to turn on one of the first and second LDO regulators to be turned on, thereby initiating a simultaneous turn-on interval, in which the first and second LDO regulators are both ON, and to configure feedback factors or reference voltages of the first and second LDO regulators at different values in the simultaneous turn-on interval, thereby adaptively turning off one of the LDO regulators to be turned off; and
based on the comparison of the first or second current monitoring circuit, the LDO regulator to be turned off is turned off, and the feedback factor or reference voltage of the LDO regulator that has been turned on is adjusted, thereby the output voltage remaining the same as before the switching.

2. The LDO regulator-based power supply circuit of claim 1, wherein a duration of the simultaneous turn-on interval is determined based on the reference voltage of the first LDO regulator, the reference voltage of the second LDO regulator, a feedback factor ratio of the first and second LDO regulators and a gain of the LDO regulator to be turned off, and in the simultaneous turn-on interval, a ratio of the reference voltage of the first LDO regulator to the reference voltage of the second LDO regulator or the feedback factor ratio of the first and second LDO regulators is adjustable and variable by the control module.

3. The LDO regulator-based power supply circuit of claim 1, wherein the control module is further configured to adjust the feedback factor or reference voltage of the LDO regulator that has been turned on after the elapse of a delay time following the turn-off of the LDO regulator to be turned off.

4. The LDO regulator-based power supply circuit of claim 1, wherein in the simultaneous turn-on interval, the control module configures the reference voltages that the first and second LDO regulators receive at equal values and the feedback factors at different values, and after the LDO regulator to be turned off is turned off, adjusts the feedback factor of the LDO regulator that has been turned on to the same value as the feedback factor of the LDO regulator to be turned off before it is turned off.

5. The LDO regulator-based power supply circuit of claim 1, wherein in the simultaneous turn-on interval, the control module configures the feedback factors of the first and second LDO regulators at equal values, and the reference voltages that they receive at different values, and after the LDO regulator to be turned off is turned off, adjusts the reference voltage of the LDO regulator that has been turned on to the same value as the feedback factor of the LDO regulator to be turned off before it is turned off.

6. The LDO regulator-based power supply circuit of claim 1, wherein the first LDO regulator comprises a first error amplifier, a first power transistor and a first feedback resistor network, the first error amplifier having a first input terminal, at which a first reference voltage is received, the first error amplifier having a second input terminal coupled to an output terminal of the first feedback resistor network, the first error amplifier having an output terminal coupled to a gate terminal of the first power transistor, the first power transistor having a source terminal coupled to a first power supply voltage, the first power transistor having a drain terminal coupled to an input terminal of the first feedback resistor network, the first feedback resistor network having a control terminal coupled to the control module, wherein the feedback factor of the first LDO regulator is defined as a ratio of a feedback voltage output from the first feedback resistor network to the output voltage.

7. The LDO regulator-based power supply circuit of claim 6, wherein when the first LDO regulator is the LDO regulator to be turned off and the second LDO regulator is the LDO regulator to be turned on, the control module configures the feedback factor of the first LDO regulator at a higher value than the feedback factor of the second LDO regulator so that the output voltage of the first error amplifier increases, thereby adaptively turning off the first power transistor.

8. The LDO regulator-based power supply circuit of claim 6, wherein the first feedback resistor network comprises a first resistor and a second resistor connected in series with the first resistor at the output terminal of the first feedback resistor network, from which the feedback voltage is output, wherein the first and second resistors are both fixed resistors, or one of the first and second resistors is a first adjustable resistor, and the control module controls resistance of the first adjustable resistor and thereby controls or adjusts the feedback factor of the first LDO regulator by outputting an associated binary code.

9. The LDO regulator-based power supply circuit of claim 6, wherein the first LDO regulator further comprises a first voltage-dividing resistor network configured to divide the reference voltage and thereby output the first reference voltage, the first voltage-dividing resistor network comprising a fifth resistor and a sixth resistor connected in series with the fifth resistor at an output terminal of the first voltage-dividing resistor network, from which the first reference voltage is output, wherein the fifth and sixth resistors are both fixed resistors, or one of the fifth and sixth resistors is a third adjustable resistor, and the control module controls resistance of the third adjustable resistor and thereby controls or adjusts the first reference voltage by outputting an associated binary code.

10. The LDO regulator-based power supply circuit of claim 1, wherein the first current monitoring circuit comprises:
a first mirror circuit, which is coupled to a first power transistor in the first LDO regulator and a first power supply voltage from the first LDO regulator and is configured to mirror a current through the first power transistor at a ratio of 1:n, where n>0;
a first current sensing circuit, which is coupled to an output terminal of the first mirror circuit and is configured to detect and determine the mirrored current output from the first mirror circuit; and
a first comparator coupled to an output terminal of the first current sensing circuit and an input terminal of the control module, the first comparator configured to compare the mirrored current detected by the first current sensing circuit with a first threshold value derived from the first threshold current, during switching from operation based on the first LDO regulator to operation based on the second LDO regulator, when the mirrored current detected by the first current sensing circuit is smaller than the first threshold value, the first comparator further configured to output a first undercurrent flag signal, the control module turns off the first LDO regulator based on the first undercurrent flag signal.

11. The LDO regulator-based power supply circuit of claim 1, wherein the second LDO regulator comprises a second error amplifier, a second power transistor and a second feedback resistor network, the second error amplifier having a first input terminal, at which a second reference voltage is received, the second error amplifier having a second input terminal coupled to an output terminal of the second feedback resistor network, the second error amplifier having an output terminal coupled to a gate terminal of the second power transistor, the second power transistor having a source terminal coupled to a second power supply voltage, the second power transistor having a drain terminal coupled to an input terminal of the second feedback resistor network, the second feedback resistor network having a control terminal coupled to the control module, wherein the feedback factor of the second LDO regulator is defined as a ratio of a feedback voltage output from the second feedback resistor network to the output voltage.

12. The LDO regulator-based power supply circuit of claim 11, wherein when the second LDO regulator is the LDO regulator to be turned off and the first LDO regulator is the LDO regulator to be turned on, the control module configures the feedback factor of the second LDO regulator at a higher value than the feedback factor of the first LDO regulator so that the output voltage of the second error amplifier adaptively increases, thereby turning off the second power transistor.

13. The LDO regulator-based power supply circuit of claim 11, wherein the second feedback resistor network comprises a third resistor and a fourth resistor connected in series with the third resistor at the output terminal of the second feedback resistor network, from which the feedback voltage is output, wherein the third and fourth resistors are both fixed resistors, or one of the third and fourth resistors is a second adjustable resistor, and the control module controls resistance of the second adjustable resistor and thereby controls or adjusts the feedback factor of the second LDO regulator by outputting an associated binary code.

14. The LDO regulator-based power supply circuit of claim 11, wherein the second LDO regulator further comprises a second voltage-dividing resistor network, the second voltage-dividing resistor network configured to divide the reference voltage and thereby output the second reference voltage, the second voltage-dividing resistor network comprising a seventh resistor and an eighth resistor connected in series with the seventh resistor at an output terminal of the second voltage-dividing resistor network, from which the second reference voltage is output, wherein the seventh and eighth resistors are both fixed resistors, or one of the seventh and eighth resistors is a fourth adjustable resistor, and the control module controls resistance of the fourth adjustable resistor and thereby controls or adjusts the second reference voltage by outputting an associated binary code.

15. The LDO regulator-based power supply circuit of claim 8, wherein at least one of the adjustable resistors in the first and second LDO regulators comprises a plurality of series-connected or parallel-connected resistor components, wherein resistances of the plurality of resistor components form a geometric sequence with a common ratio of 2 or 1/2.

16. The LDO regulator-based power supply circuit of claim 8, wherein at least one of the plurality of resistor components is implemented by a polysilicon resistor, an SMD resistor, a MOS resistor, a carbon film resistor, a metal film resistor or a metal oxide film resistor.

17. The LDO regulator-based power supply circuit of claim 1, wherein the second current monitoring circuit comprises:
a second mirror circuit which is coupled to a second power transistor in the second LDO regulator and a second power supply voltage from the second LDO regulator and is configured to mirror a current through the second power transistor at a ratio of 1:m, where m>0;
a second current sensing circuit, which is coupled to an output terminal of the second mirror circuit and is configured to detect and determine the mirrored current output from the second mirror circuit; and
a second comparator coupled to an output terminal of the second current sensing circuit and another input terminal of the control module, the second comparator configured to compare the mirrored current detected by the second current sensing circuit with a second threshold value derived from the second threshold current, during switching from operation based on the second LDO regulator to operation based on the first LDO regulator, when the mirrored current detected by the second current sensing circuit is smaller than the second threshold value, the second comparator further configured to output a second undercurrent flag signal, the control module turns off the second LDO regulator based on the second undercurrent flag signal.

18. The LDO regulator-based power supply circuit of claim 1, wherein the first and second LDO regulators are provided within a single chip, and the first LDO regulator provides a higher power supply voltage than the second LDO regulator, wherein a need for switching between the LDO regulators occurs after initial startup of the chip, when the second LDO regulator is the LDO regulator to be turned on and the first LDO regulator is the LDO regulator to be turned off following switching of the chip from a stop mode to a run mode, or when the first LDO regulator is the LDO regulator to be turned on and the second LDO regulator is the LDO regulator to be turned off following switching of the chip from the run mode to the stop mode.

19. A chip comprising: the LDO regulator-based power supply circuit of claim 1; and a load circuit coupled to the output voltage provided by the LDO regulator-based power supply circuit.

20. The chip of claim 19, wherein a duration of the simultaneous turn-on interval is determined based on the reference voltage of the first LDO regulator, the reference voltage of the second LDO regulator, a feedback factor ratio of the first and second LDO regulators and a gain of the LDO regulator to be turned off, and in the simultaneous turn-on interval, a ratio of the reference voltage of the first LDO regulator to the reference voltage of the second LDO regulator or the feedback factor ratio of the first and second LDO regulators is adjustable and variable by the control module.
